(19) United States
(12) Patent Application Publication
(10) Pub. No.: US 2025/0056442 A1
(43) Pub. Date: Feb. 13, 2025

(54) NON-CELL-DEFINING SYNCHRONIZATION SIGNAL BLOCKS

(71) Applicant: QUALCOMM Incorporated, San Diego, CA (US)

(72) Inventors: Kazuki TAKEDA, Tokyo (JP); Jing LEI, San Diego, CA (US); Changhwan PARK, San Diego, CA (US); Peter GAAL, San Diego, CA (US)

(21) Appl. No.: 18/655,706

(22) Filed: May 6, 2024

Related U.S. Application Data
(60) Provisional application No. 63/518,047, filed on Aug. 7, 2023.

(51) Int. Cl. H04W 56/00; H04W 16/28; H04W 72/0457; H04W 74/0833

(52) U.S. Cl. CPC H04W 56/0015; H04W 16/28; H04W 72/0457; H04W 74/0833

(57) ABSTRACT

Various aspects of the present disclosure generally relate to wireless communication. In some aspects, a user equipment (UE) may receive a configuration for a bandwidth part (BWP). The BWP may overlap with one or more first frequency resources associated with a cell-defining synchronization signal block (CD-SSB) and one or more second frequency resources associated with a non-cell-defining synchronization signal block (NCD-SSB). The UE may perform a measurement using the NCD-SSB (and not the CD-SSB) during an active state of the BWP. Numerous other aspects are described.

### CROSS-REFERENCE TO RELATED APPLICATION

This Patent Application claims priority to U.S. Provisional Application No. 63/518,047, filed on Aug. 7, 2023, entitled “NON-CELL-DEFINING SYNCHRONIZATION SIGNAL BLOCKS,” and assigned to the assignee hereof The disclosure of the prior Application is considered part of and is incorporated by reference into this Patent Application.

### FIELD OF THE DISCLOSURE

Aspects of the present disclosure generally relate to wireless communication and to techniques and apparatuses for configuring and using non-cell-defining synchronization signal blocks.

### BACKGROUND

Wireless communication systems are widely deployed to provide various telecommunication services such as telephony, video, data, messaging, and broadcasts.

Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration for a bandwidth part (BWP), the BWP overlapping with one or more first frequency resources associated with a cell-defining synchronization signal block (CD-SSB) and one or more second frequency resources associated with a non-cell-defining synchronization signal block (NCD-SSB). The method may include performing a measurement using the CD-SSB during an active state of the BWP.

Some aspects described herein relate to a method of wireless communication performed by a network node. The method may include transmitting a configuration for a BWP, the BWP overlapping with one or more first frequency resources associated with an NCD-SSB, wherein the configuration omits an information element associated with the NCD-SSB based on the BWP overlapping with second frequency resources associated with a CD-SSB. The method may include transmitting an instruction to move the BWP into an active state.

Some aspects described herein relate to a method of wireless communication performed by a UE. The method may include receiving a configuration for a BWP, the configuration indicating an NCD-SSB included in the BWP, and the BWP overlapping with one or more frequency resources associated with a CD-SSB. The method may include performing a measurement using the NCD-SSB during an active state of the BWP.

Some aspects described herein relate to a method of wireless communication performed by a network node. The method may include transmitting a configuration for a BWP, the configuration indicating an NCD-SSB included in the BWP, and the BWP overlapping with one or more frequency resources associated with a CD-SSB. The method may include transmitting an instruction to move the BWP into an active state.

Some aspects described herein relate to a method of wireless communication performed by a UE. The method may include receiving a configuration for a BWP, the configuration indicating an NCD-SSB included in the BWP, and the BWP including one or more frequency resources associated with a CD-SSB. The method may include performing a measurement using at least one of the CD-SSB or the NCD-SSB during an active state of the BWP.

Some aspects described herein relate to a method of wireless communication performed by a network node. The method may include transmitting a configuration for a BWP, the configuration indicating an NCD-SSB included in the BWP, and the BWP overlapping with one or more frequency resources associated with a CD-SSB. The method may include receiving an indication of a first measurement, based at least in part on the NCD-SSB, during an active state of the BWP. The method may include receiving an indication of a second measurement, based at least in part on the CD-SSB, during the active state of the BWP.

Some aspects described herein relate to a method of wireless communication performed by a UE. The method may include receiving a configuration for a secondary cell (SCell), the SCell being in a dormant state or a deactivated state. The method may include performing a measurement on the SCell using an NCD-SSB.

Some aspects described herein relate to a method of wireless communication performed by a network node. The method may include transmitting a configuration for an SCell, the SCell being in a dormant state or a deactivated state. The method may include transmitting a configuration associated with an NCD-SSB for use in the SCell.

Some aspects described herein relate to a non-transitory computer-readable medium that stores a set of instructions for wireless communication by a UE. The set of instructions, when executed by one or more processors of the UE, may cause the UE to receive a configuration for a BWP, the BWP overlapping with one or more first frequency resources associated with a CD-SSB and one or more second frequency resources associated with an NCD-SSB. The set of instructions, when executed by one or more processors of the UE, may cause the UE to perform a measurement using the CD-SSB during an active state of the BWP.

Some aspects described herein relate to a non-transitory computer-readable medium that stores a set of instructions for wireless communication by a network node. The set of instructions, when executed by one or more processors of the network node, may cause the network node to transmit a configuration for a BWP, the BWP overlapping with one or more first frequency resources associated with an NCD-SSB, wherein the configuration omits an information element (IE) associated with the NCD-SSB based on the BWP overlapping with second frequency resources associated with a CD-SSB. The set of instructions, when executed by one or more processors of the network node, may cause the network node to transmit an instruction to move the BWP into an active state.

Some aspects described herein relate to a non-transitory computer-readable medium that stores a set of instructions for wireless communication by a UE. The set of instructions, when executed by one or more processors of the UE, may cause the UE to receive a configuration for a BWP, the configuration indicating an NCD-SSB included in the BWP, and the BWP overlapping with one or more frequency resources associated with a CD-SSB. The set of instructions, when executed by one or more processors of the UE, may cause the UE to perform a measurement using the NCD-SSB during an active state of the BWP.

Some aspects described herein relate to a non-transitory computer-readable medium that stores a set of instructions for wireless communication by a network node. The set of instructions, when executed by one or more processors of the network node, may cause the network node to transmit a configuration for a BWP, the configuration indicating an NCD-SSB included in the BWP, and the BWP overlapping with one or more frequency resources associated with a CD-SSB. The set of instructions, when executed by one or more processors of the network node, may cause the network node to transmit an instruction to move the BWP into an active state.

Some aspects described herein relate to a non-transitory computer-readable medium that stores a set of instructions for wireless communication by a UE. The set of instructions, when executed by one or more processors of the UE, may cause the UE to receive a configuration for a BWP, the configuration indicating an NCD-SSB included in the BWP, and the BWP including one or more frequency resources associated with a CD-SSB. The set of instructions, when executed by one or more processors of the UE, may cause the UE to perform a measurement using at least one of the CD-SSB or the NCD-SSB during an active state of the BWP.

Some aspects described herein relate to a non-transitory computer-readable medium that stores a set of instructions for wireless communication by a network node. The set of instructions, when executed by one or more processors of the network node, may cause the network node to transmit a configuration for a BWP, the configuration indicating an NCD-SSB included in the BWP, and the BWP overlapping with one or more frequency resources associated with a CD-SSB. The set of instructions, when executed by one or more processors of the network node, may cause the network node to receive an indication of a first measurement, based at least in part on the NCD-SSB, during an active state of the BWP. The set of instructions, when executed by one or more processors of the network node, may cause the network node to receive an indication of a second measurement, based at least in part on the CD-SSB, during the active state of the BWP.

Some aspects described herein relate to a non-transitory computer-readable medium that stores a set of instructions for wireless communication by a UE. The set of instructions, when executed by one or more processors of the UE, may cause the UE to receive a configuration for an SCell, the SCell being in a dormant state or a deactivated state. The set of instructions, when executed by one or more processors of the UE, may cause the UE to perform a measurement on the SCell using an NCD-SSB.

Some aspects described herein relate to a non-transitory computer-readable medium that stores a set of instructions for wireless communication by a network node. The set of instructions, when executed by one or more processors of the network node, may cause the network node to transmit a configuration for an SCell, the SCell being in a dormant state or a deactivated state. The set of instructions, when executed by one or more processors of the network node, may cause the network node to transmit a configuration associated with an NCD-SSB for use in the SCell.

Some aspects described herein relate to an apparatus for wireless communication. The apparatus may include means for receiving a configuration for a BWP, the BWP overlapping with one or more first frequency resources associated with a CD-SSB and one or more second frequency resources associated with an NCD-SSB. The apparatus may include means for performing a measurement using the CD-SSB during an active state of the BWP.

Some aspects described herein relate to an apparatus for wireless communication. The apparatus may include means for transmitting a configuration for a BWP, the BWP overlapping with one or more first frequency resources associated with an NCD-SSB, wherein the configuration omits an information element associated with the NCD-SSB based on the BWP overlapping with second frequency resources associated with a CD-SSB. The apparatus may include means for transmitting an instruction to move the BWP into an active state.

Some aspects described herein relate to an apparatus for wireless communication. The apparatus may include means for receiving a configuration for a BWP, the configuration indicating an NCD-SSB included in the BWP, and the BWP overlapping with one or more frequency resources associated with a CD-SSB. The apparatus may include means for performing a measurement using the NCD-SSB during an active state of the BWP.

Some aspects described herein relate to an apparatus for wireless communication. The apparatus may include means for transmitting a configuration for a BWP, the configuration indicating an NCD-SSB included in the BWP, and the BWP overlapping with one or more frequency resources associated with a CD-SSB. The apparatus may include means for transmitting an instruction to move the BWP into an active state.

Some aspects described herein relate to an apparatus for wireless communication. The apparatus may include means for receiving a configuration for a BWP, the configuration indicating an NCD-SSB included in the BWP, and the BWP including one or more frequency resources associated with a CD-SSB. The apparatus may include means for performing a measurement using at least one of the CD-SSB or the NCD-SSB during an active state of the BWP.

Some aspects described herein relate to an apparatus for wireless communication. The apparatus may include means for transmitting a configuration for a BWP, the configuration indicating an NCD-SSB included in the BWP, and the BWP overlapping with one or more frequency resources associated with a CD-SSB. The apparatus may include means for receiving an indication of a first measurement, based at least in part on the NCD-SSB, during an active state of the BWP. The apparatus may include means for receiving an indication of a second measurement, based at least in part on the CD-SSB, during the active state of the BWP.

Some aspects described herein relate to an apparatus for wireless communication. The apparatus may include means for receiving a configuration for an SCell, the SCell being in a dormant state or a deactivated state. The apparatus may include means for performing a measurement on the SCell using an NCD-SSB.

Some aspects described herein relate to an apparatus for wireless communication. The apparatus may include means for transmitting a configuration for an SCell, the SCell being in a dormant state or a deactivated state. The apparatus may include means for transmitting a configuration associated with an NCD-SSB for use in the SCell.

Some aspects described herein relate to an apparatus for wireless communication at a UE. The apparatus may include one or more memories and one or more processors. The one or more processors may be, individually or collectively and based at least in part on information stored in the one or more memories, configured to receive a configuration for a BWP, the BWP overlapping with one or more first frequency resources associated with a CD-SSB and one or more second frequency resources associated with an NCD-SSB. The one or more processors may be, individually or collectively and based at least in part on information stored in the one or more memories, configured to perform a measurement using the CD-SSB during an active state of the BWP.

Some aspects described herein relate to an apparatus for wireless communication at a network node. The apparatus may include one or more memories and one or more processors. The one or more processors may be, individually or collectively and based at least in part on information stored in the one or more memories, configured to transmit a configuration for a BWP, the BWP overlapping with one or more first frequency resources associated with an NCD-SSB, wherein the configuration omits an information element associated with the NCD-SSB based on the BWP overlapping with second frequency resources associated with a CD-SSB. The one or more processors may be, individually or collectively and based at least in part on information stored in the one or more memories, configured to transmit an instruction to move the BWP into an active state.

Some aspects described herein relate to an apparatus for wireless communication at a UE. The apparatus may include one or more memories and one or more processors. The one or more processors may be, individually or collectively and based at least in part on information stored in the one or more memories, configured to receive a configuration for a BWP, the configuration indicating an NCD-SSB included in the BWP, and the BWP overlapping with one or more frequency resources associated with a CD-SSB. The one or more processors may be, individually or collectively and based at least in part on information stored in the one or more memories, configured to perform a measurement using the NCD-SSB during an active state of the BWP.

Some aspects described herein relate to an apparatus for wireless communication at a network node. The apparatus may include one or more memories and one or more processors. The one or more processors may be, individually or collectively and based at least in part on information stored in the one or more memories, configured to transmit a configuration for a BWP, the configuration indicating an NCD-SSB included in the BWP, and the BWP overlapping with one or more frequency resources associated with a CD-SSB. The one or more processors may be configured to transmit an instruction to move the BWP into an active state.

Some aspects described herein relate to an apparatus for wireless communication at a UE. The apparatus may include one or more memories and one or more processors. The one or more processors may be, individually or collectively and based at least in part on information stored in the one or more memories, configured to receive a configuration for a BWP, the configuration indicating an NCD-SSB included in the BWP, and the BWP including one or more frequency resources associated with a CD-SSB. The one or more processors may be, individually or collectively and based at least in part on information stored in the one or more memories, configured to perform a measurement using at least one of the CD-SSB or the NCD-SSB during an active state of the BWP.

Some aspects described herein relate to an apparatus for wireless communication at a network node. The apparatus may include one or more memories and one or more processors. The one or more processors may be, individually or collectively and based at least in part on information stored in the one or more memories, configured to transmit a configuration for a BWP, the configuration indicating an NCD-SSB included in the BWP, and the BWP overlapping with one or more frequency resources associated with a CD-SSB. The one or more processors may be, individually or collectively and based at least in part on information stored in the one or more memories, configured to receive an indication of a first measurement, based at least in part on the NCD-SSB, during an active state of the BWP. The one or more processors may be, individually or collectively and based at least in part on information stored in the one or more memories, configured to receive an indication of a second measurement, based at least in part on the CD-SSB, during the active state of the BWP.

Some aspects described herein relate to an apparatus for wireless communication at a UE. The apparatus may include one or more memories and one or more processors. The one or more processors may be, individually or collectively and based at least in part on information stored in the one or more memories, configured to receive a configuration for an SCell, the SCell being in a dormant state or a deactivated state. The one or more processors may be, individually or collectively and based at least in part on information stored in the one or more memories, configured to perform a measurement on the SCell using an NCD-SSB.

Some aspects described herein relate to an apparatus for wireless communication at a network node. The apparatus may include one or more memories and one or more processors. The one or more processors may be, individually or collectively and based at least in part on information stored in the one or more memories, configured to transmit a configuration for an SCell, the SCell being in a dormant state or a deactivated state. The one or more processors may be, individually or collectively and based at least in part on information stored in the one or more memories, configured to transmit a configuration associated with an NCD-SSB for use in the SCell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example of a synchronization signal hierarchy, in accordance with the present disclosure.

FIGS. 5, 6, 7, and 8 are diagrams illustrating examples associated with configuring and using non-cell-defining synchronization signal blocks (NCD-SSBs), in accordance with the present disclosure.

FIGS. 9, 10, 11, 12, 13, 14, 15, and 16 are diagrams illustrating example processes associated with configuring and using NCD-SSBs, in accordance with the present disclosure.

FIGS. 17 and 18 are diagrams of example apparatuses for wireless communication, in accordance with the present disclosure.

### DETAILED DESCRIPTION

A user equipment (UE) may perform measurements (e.g., layer 1 (L1) measurements and/or layer 3 (L3) measurements) while connected to a wireless network. Many measurements are performed on a synchronization signal block (SSB).

As used herein, “SSB” refers to a signal that carries information used for initial network acquisition and synchronization, such as primary synchronization signal (PSS), a secondary synchronization signal (SSS), a physical broadcast channel (PBCH), and a PBCH demodulation reference signal (DMRS). Accordingly, an SSB is sometimes referred to as a synchronization signal/PBCH (SS/PBCH) block. A UE may also use different bandwidth parts (BWPs) for communicating on the wireless network. As used herein, “bandwidth part” or “BWP” may refer to a contiguous set of physical resource blocks (PRBs), where each PRB includes a set of frequencies corresponding to one or more subcarriers. “Subcarrier” may refer to a frequency based at least in part on a “carrier” frequency, and subcarriers may be aggregated (e.g., using carrier aggregation (CA)) to convey information wirelessly (e.g., using OFDM symbols and/or other RF symbols). When a UE switches BWPs in the case of BWP with restriction, each active BWP includes a cell-defining SSB (CD-SSB). As used herein, a “CD-SSB” refers to an SSB that indicates a system information broadcast (SIB) message including an identifier associated with the cell (e.g., an NR cell global identity (NCGI)). When a UE switches BWPs in the case of BWP without restriction, an active BWP may include a non-cell-defining SSB (NCD-SSB) (e.g., an SSB that does not indicate the SIB message and/or indicates a SIB message not including the identifier associated with the cell). However, a BWP may overlap with both a CD-SSB and an NCD-SSB. The UE may report inaccurate measurements if the UE selects an incorrect SSB to measure, and thus the UE and the wireless network may experience reduced quality and reliability of communications because transmission parameters are selected based on the inaccurate measurements. Reduced quality and reliability of communications also increase chances of retransmissions, which waste power, processing resources, and network overhead.

Various aspects relate generally to wireless communication and more particularly to selecting whether to use an NCD-SSB for measurement and collision resolution when an active BWP overlaps with both a CD-SSB and an NCD-SSB. Some aspects more specifically relate to using the CD-SSB, when available, regardless of whether an NCD-SSB is configured and/or overlapping. Alternatively, some aspects more specifically relate to using an NCD-SSB, when configured, regardless of whether the CD-SSB is overlapping. Alternatively, some aspects more specifically relate to using both the CD-SSB, when overlapping, and any configured NCD-SSBs. Some aspects more specifically relate to using an NCD-SSB for measurements on a secondary cell (SCell) that is in a dormant state or a deactivated state.

Particular aspects of the subject matter described in this disclosure can be implemented to realize one or more of the following potential advantages. In some examples, because the UE always uses the CD-SSB when overlapping with an active BWP, the UE and the network may perform collision resolution in the active BWP with few processing resources and little memory overhead. In some examples, because the network controls whether an NCD-SSB is configured for an active BWP, the network may exercise greater control over measurements performed by the UE. As a result, the network may choose whether UE will use a CD-SSB or an NCD-SSB, and the network may thus increase quality and reliability of communications because transmission parameters are selected based on measurements of the SSB chosen by the network. In some examples, because the UE uses both the CD-SSB and the NCD-SSB, the UE minimizes collision between the SSBs and uplink or downlink transmissions, which increases quality and reliability of communications. In some examples, because the network may configure the UE to use an NCD-SSB in an SCell, the network may thus increase quality and reliability of communications with the SCell because transmission parameters are selected based on measurements of the SSB chosen by the network.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

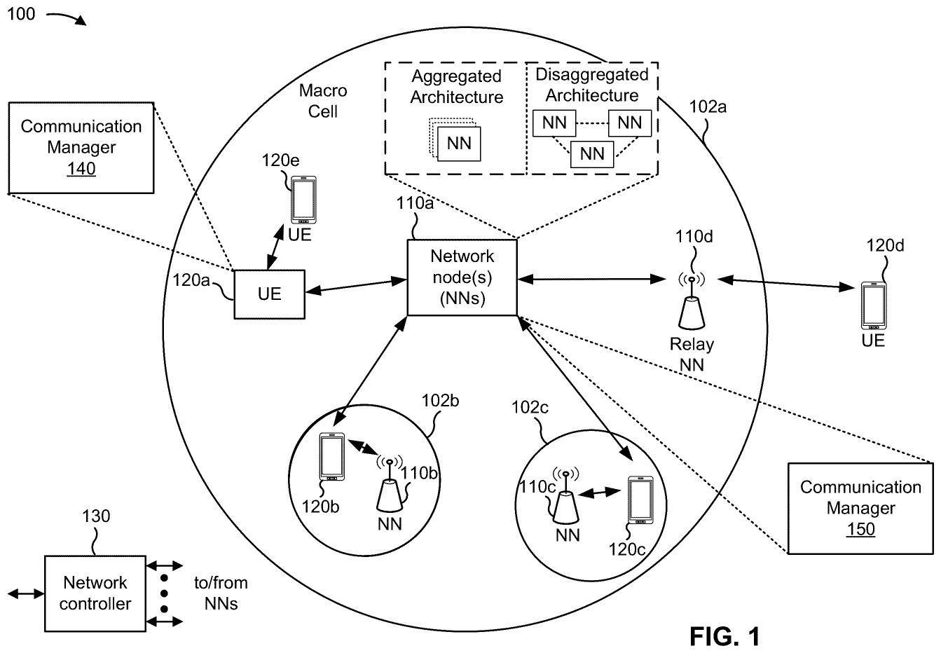

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration for a BWP that overlaps with one or more first frequency resources associated with a CD-SSB and one or more second frequency resources associated with an NCD-SSB and may perform a measurement using the CD-SSB during an active state of the BWP. Alternatively, as described in more detail elsewhere herein, the communication manager 140 may receive a configuration for BWP, the configuration indicating an NCD-SSB included in the BWP, and the BWP overlapping with one or more frequency resources associated with a CD-SSB, and may perform a measurement using the NCD-SSB during an active state of the BWP. Alternatively, as described in more detail elsewhere herein, the communication manager 140 may receive a configuration for a BWP, the configuration indicating an NCD-SSB included in the BWP, and the BWP including one or more frequency resources associated with a SSB, and may perform a measurement using at least one of the CD-SSB or the NCD-SSB during an active state of the BWP. Additionally, or alternatively, as described in more detail elsewhere herein, the communication manager 140 may receive a configuration for an SCell, the SCell being in a dormant state or a deactivated state, and may perform a measurement on the SCell using an NCD-SSB. Additionally, or alternatively, the communication manager 140 may perform one or more other operations described herein.

In some aspects, the network node 110 may include a communication manager 150. As described in more detail elsewhere herein, the communication manager 150 may transmit a configuration for a BWP, the BWP overlapping with one or more first frequency resources associated with an NCD-SSB, and the configuration omitting an information element associated with the NCD-SSB based on the BWP overlapping with second frequency resources associated with a CD-SSB, and may transmit an instruction to move the BWP into an active state. Alternatively, as described in more detail elsewhere herein, the communication manager 150 may transmit a configuration for a BWP, the configuration indicating an NCD-SSB included in the BWP, and the BWP overlapping with one or more frequency resources associated with a CD-SSB, and may transmit an instruction to move the BWP into an active state. Alternatively, as described in more detail elsewhere herein, the communication manager 150 may transmit a configuration for a BWP, the configuration indicating an NCD-SSB included in the BWP, and the BWP overlapping with one or more frequency resources associated with a CD-SSB, may receive an indication of a first measurement, based at least in part on the NCD-SSB, during an active state of the BWP, and may receive an indication of a second measurement, based at least in part on the CD-SSB, during the active state of the BWP. Additionally, or alternatively, as described in more detail elsewhere herein, the communication manager 150 may transmit a configuration for an SCell, the SCell being in a dormant state or a deactivated state, and may transmit a configuration associated with an NCD-SSB for use in the SCell. Additionally, or alternatively, the communication manager 150 may perform one or more other operations described herein.

As indicated above, FIG. 1 is provided as an example. Other examples may differ from what is described with regard to FIG. 1.

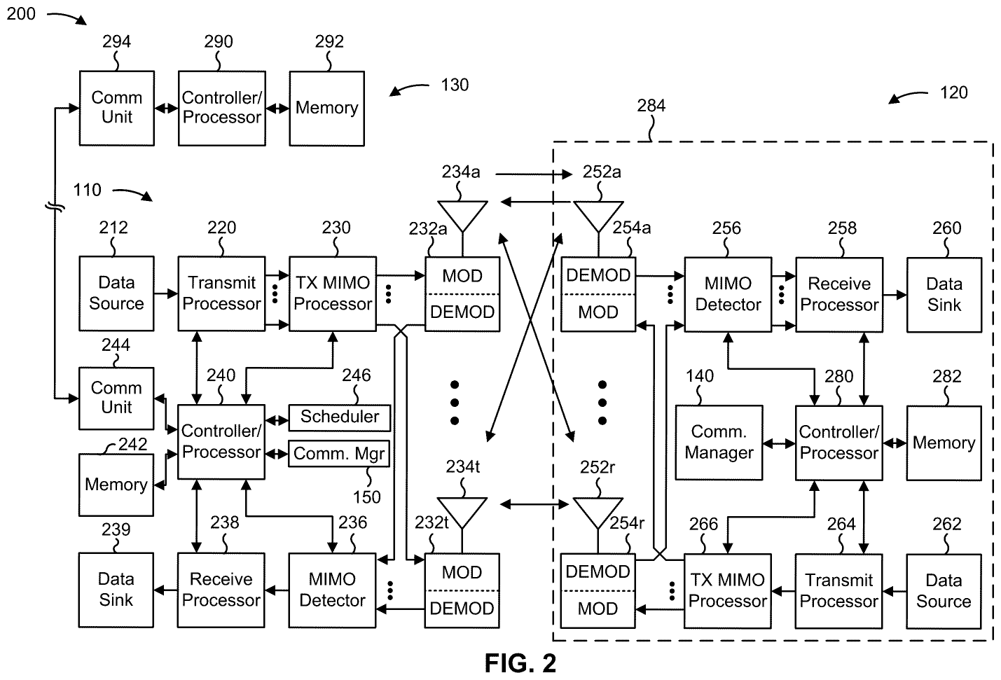

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a DMRS) and synchronization signals (e.g., a PSS or an SSS). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

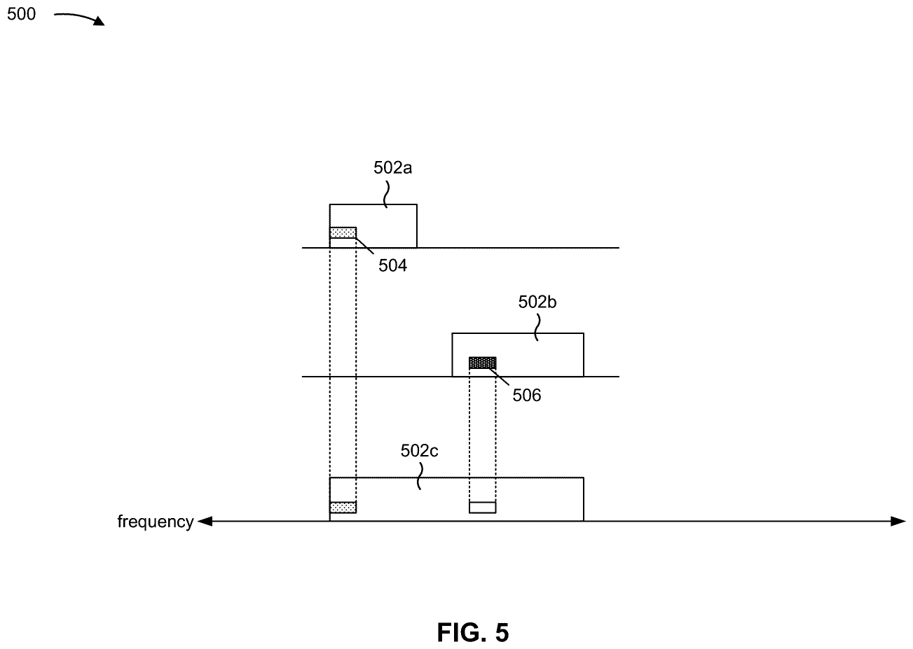

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-18).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-18).

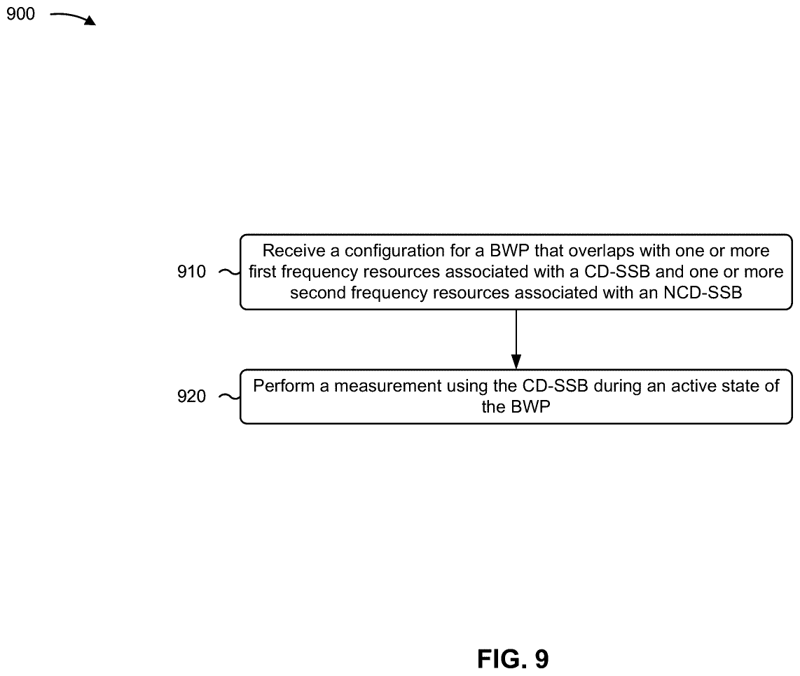

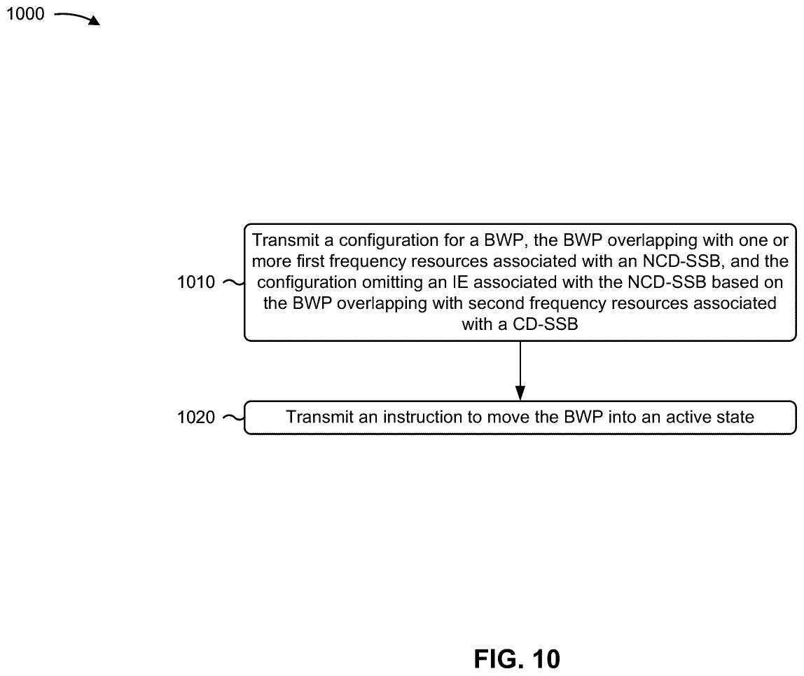

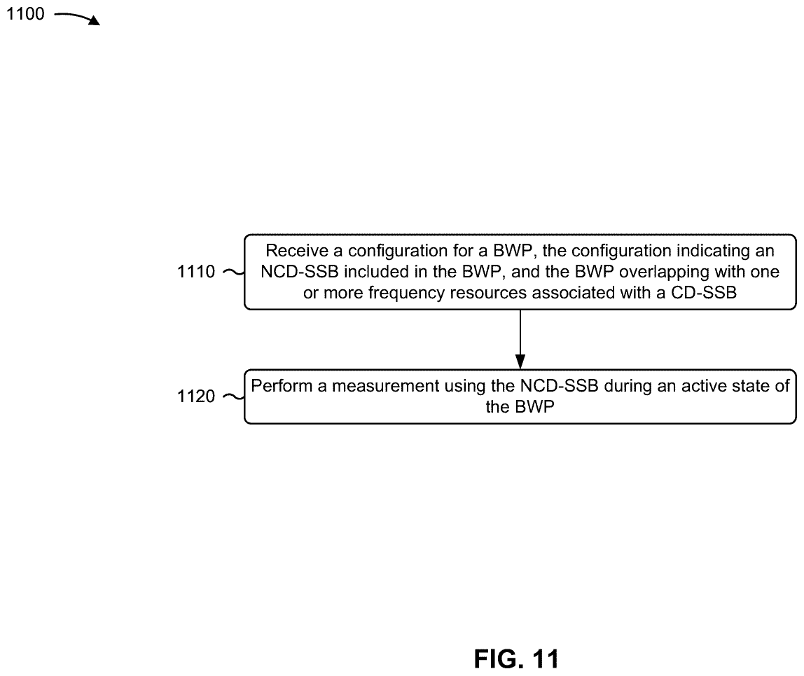

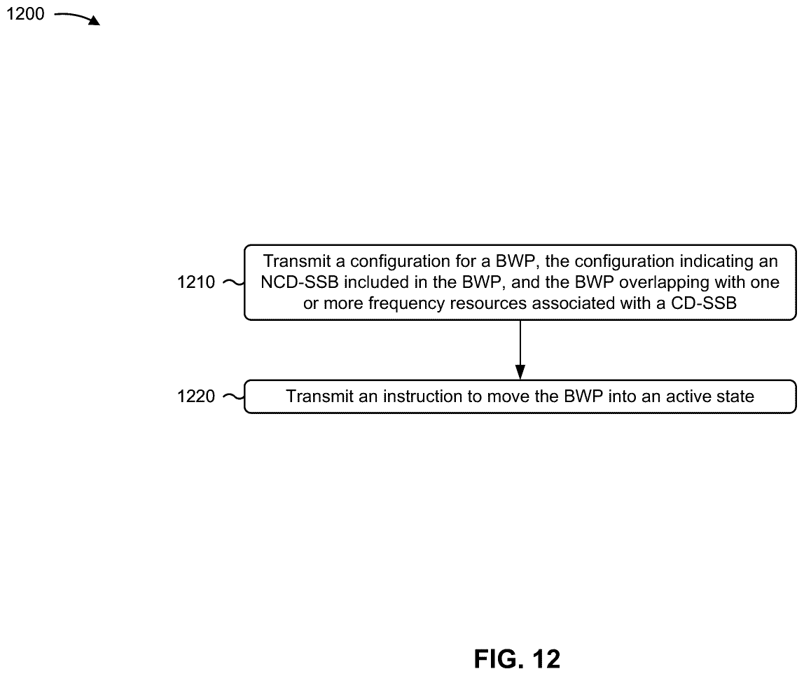

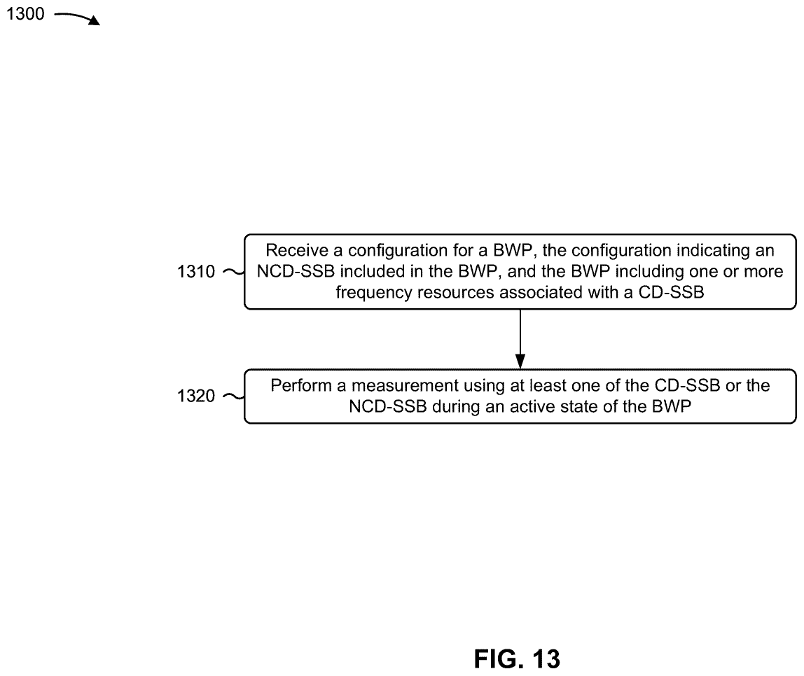

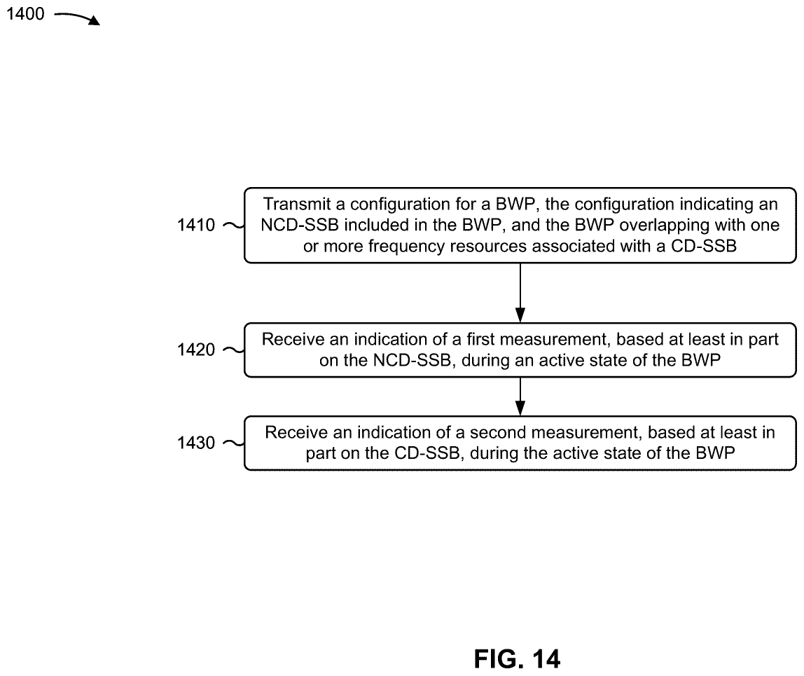

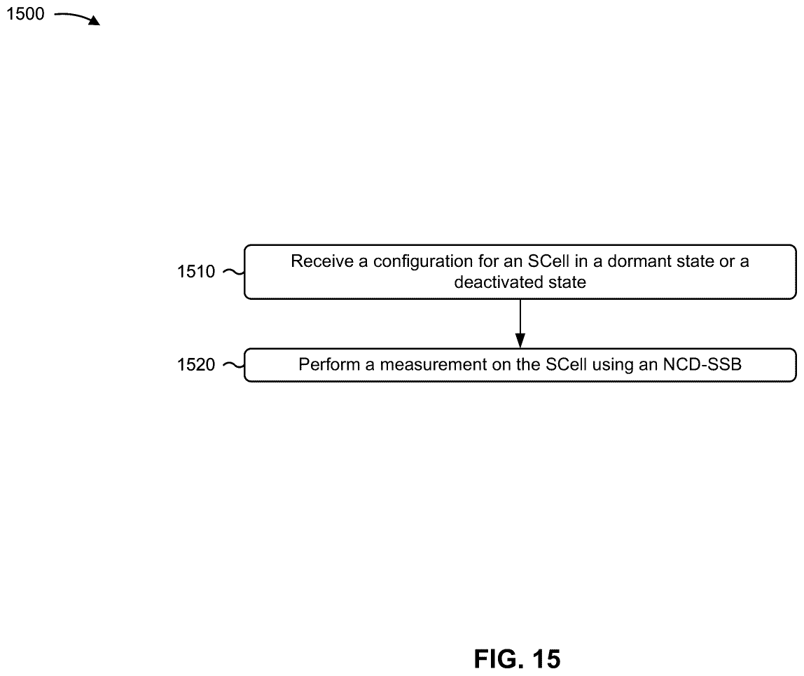

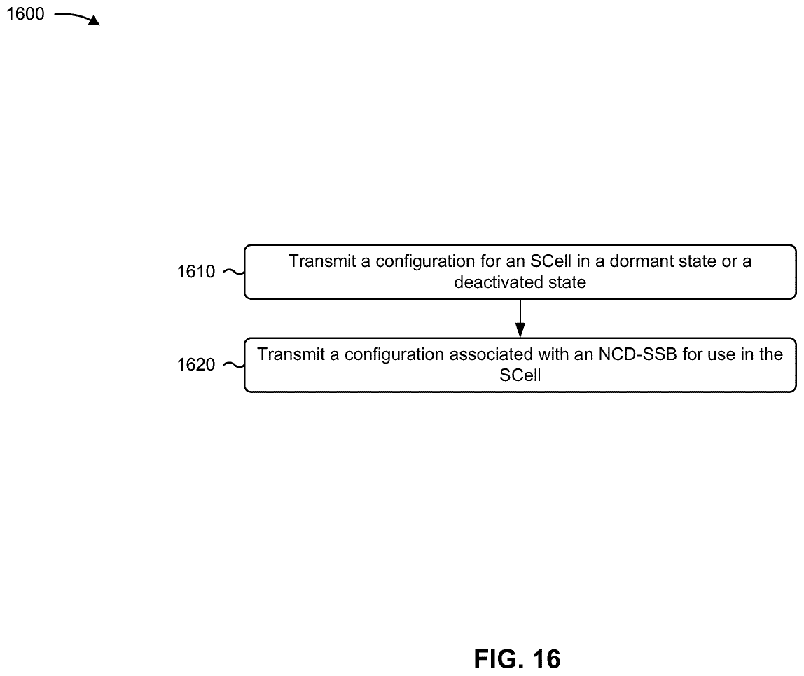

The controller/processor 240 of the network node 110, the controller/processor 280 of the UE 120, and/or any other component(s) of FIG. 2 may perform one or more techniques associated with configuring and using NCD-SSBs, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, process 1300 of FIG. 13, process 1400 of FIG. 14, process 1500 of FIG. 15, process 1600 of FIG. 16, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, process 1200 of FIG. 12, process 1300 of FIG. 13, process 1400 of FIG. 14, process 1500 of FIG. 15, process 1600 of FIG. 16, and/or other processes as described herein. In some examples, executing instructions may include running the instructions, converting the instructions, compiling the instructions, and/or interpreting the instructions, among other examples.

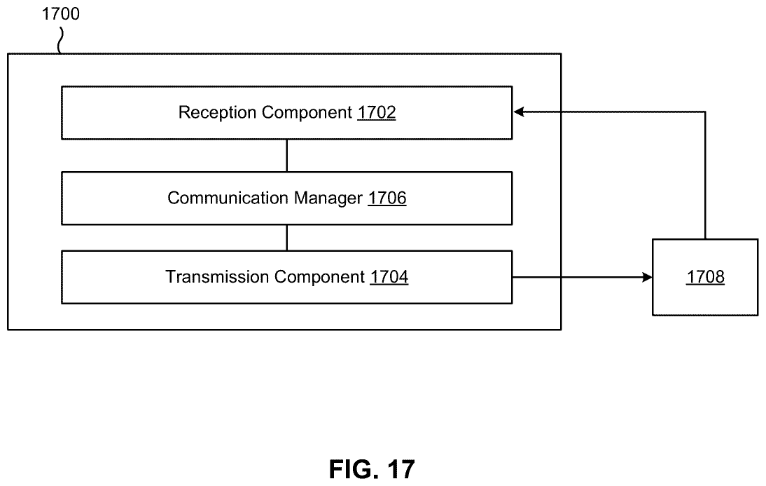

In some aspects, a UE (e.g., the UE 120 and/or apparatus 1700 of FIG. 17) may include means for receiving a configuration for a BWP, the BWP overlapping with one or more first frequency resources associated with a CD-SSB and one or more second frequency resources associated with an NCD-SSB, and/or means for performing a measurement using the CD-SSB during an active state of the BWP. Alternatively, the UE may include means for receiving a configuration for a BWP, the configuration indicating an NCD-SSB included in the BWP, and the BWP overlapping with one or more frequency resources associated with a CD-SSB, and/or means for performing a measurement using the NCD-SSB during an active state of the BWP. Alternatively, the UE may include means for receiving a configuration for a BWP, the configuration indicating an NCD-SSB included in the BWP, and the BWP including one or more frequency resources associated with a CD-SSB, and/or means for performing a measurement using at least one of the CD-SSB or the NCD-SSB during an active state of the BWP. Additionally, or alternatively, the UE may include means for receiving a configuration for an SCell, the SCell being in a dormant state or a deactivated state, and/or means for performing a measurement on the SCell using an NCD-SSB. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

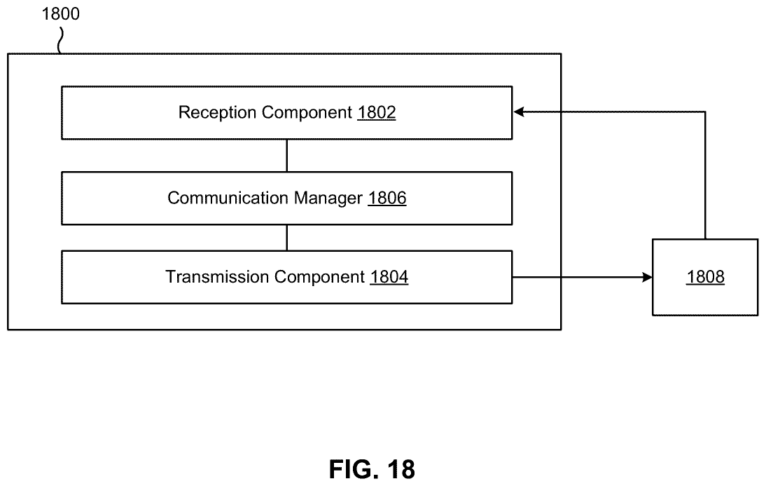

In some aspects, a network node (e.g., the network node 110, an RU 340, a DU 330, a CU 310, and/or apparatus 1800 of FIG. 18) may include means for transmitting a configuration for a BWP, the BWP overlapping with one or more first frequency resources associated with an NCD-SSB, and the configuration omitting an information element associated with the NCD-SSB based on the BWP overlapping with second frequency resources associated with a CD-SSB, and/or means for transmitting an instruction to move the BWP into an active state. Alternatively, the network node may include means for transmitting a configuration for a BWP, the configuration indicating an NCD-SSB included in the BWP, and the BWP overlapping with one or more frequency resources associated with a CD-SSB, and/or means for transmitting an instruction to move the BWP into an active state. Alternatively, the network node may include means for transmitting a configuration for a BWP, the configuration indicating an NCD-SSB included in the BWP, and the BWP overlapping with one or more frequency resources associated with a CD-SSB; means for receiving an indication of a first measurement, based at least in part on the NCD-SSB, during an active state of the BWP; and/or means for receiving an indication of a second measurement, based at least in part on the CD-SSB, during the active state of the BWP. Additionally, or alternatively, the network node may include means for transmitting a configuration for an SCell, the SCell being in a dormant state or a deactivated state, and/or means for transmitting a configuration associated with an NCD-SSB for use in the SCell. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

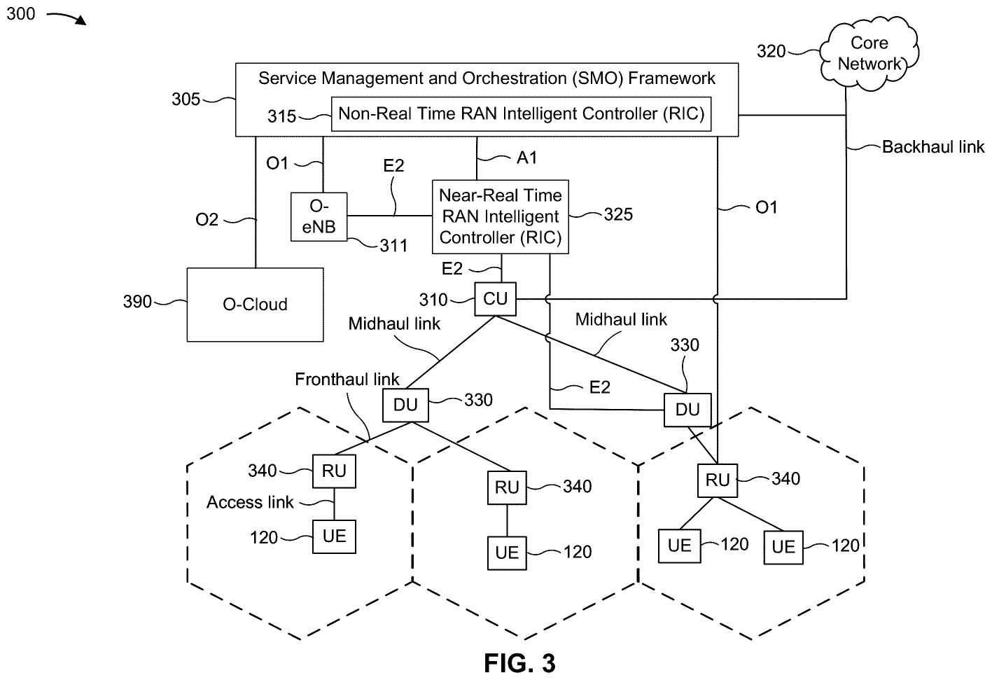

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

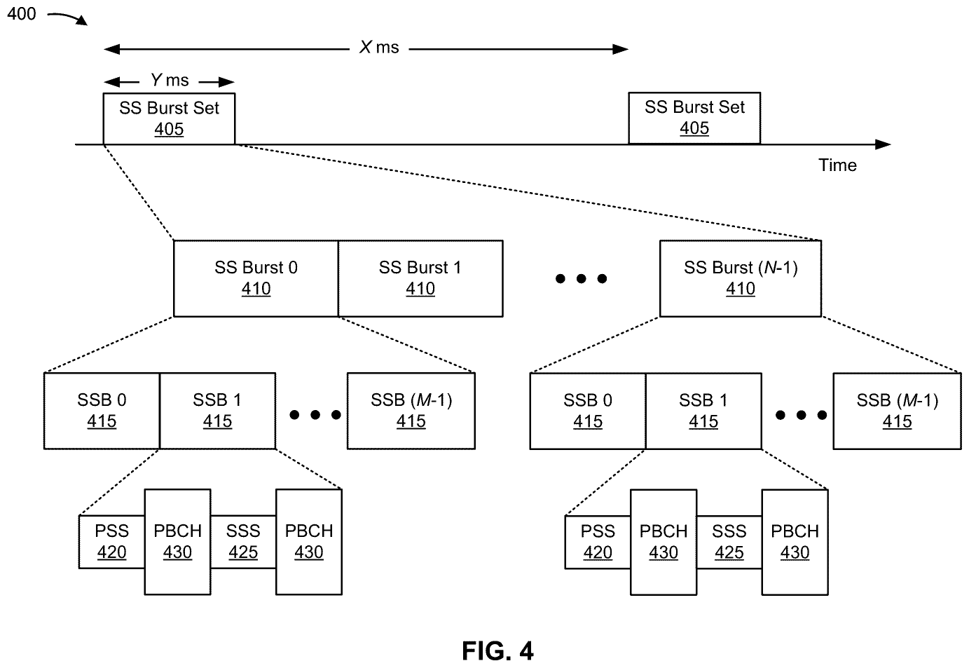

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SSBs 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a PSS 420, an SSS 425, and/or a PBCH 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., an RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

An SSB may be a CD-SSB or an NCD-SSB. However, a BWP that is activated for a UE may overlap with both a CD-SSB and an NCD-SSB. Therefore, the UE may report inaccurate measurements to a network node if the UE selects an incorrect SSB to measure. As a result, the UE and the network node may experience reduced quality and reliability of communications because transmission parameters are selected based on the inaccurate measurements. Reduced quality and reliability of communications also increase chances of retransmissions, which waste power, processing resources, and network overhead.

Additionally, the UE may select whether to use the CD-SSB or an NCD-SSB for resolving a collision with a downlink reception or an uplink transmission. For example, the UE may rate-match a downlink reception around the CD-SSB or an NCD-SSB or may cancel an uplink transmission that overlaps with the CD-SSB or an NCD-SSB. However, the UE may select the CD-SSB when the network node selects an NCD-SSB, or the network node may select an NCD-SSB when the UE selects the CD-SSB. As a result, the downlink reception or uplink transmission is likely to fair, which increase results in a retransmission that wastes power, processing resources, and network overhead.

Some techniques and apparatuses described herein enable a UE (e.g., the UE 120) to select whether to use an NCD-SSB for measurement and collision resolution when an active BWP overlaps with both a CD-SSB and an NCD-SSB. The UE 120 may select the SSB based on rules that are also used by a network node (e.g., the network node 110). As a result, the network node 110 may improve quality and reliability of communications because transmission parameters are selected based on measurements of the SSB selected by both the UE 120 and the network node 110.

Additionally, the network node 110 and the UE 120 select a same SSB for resolving a collision with a downlink reception or an uplink transmission, which conserves power, processing resources, and network overhead that would otherwise have been wasted on a retransmission.

As indicated above, FIG. 4 is provided as an example. Other examples may differ from what is described with regard to FIG. 4.

FIG. 5 is a diagram illustrating an example 500 associated with configuring and using NCD-SSBs, in accordance with the present disclosure. As shown in FIG. 5, example 500 includes a first BWP 502a, a second BWP 502b, and a third BWP 502c for a UE 120. Each BWP may be configured by a network using a BWP-DownlinkDedicated information element (IE) (e.g., as defined in 3GPP specifications).

The first BWP 502a overlaps with frequency resources that include a CD-SSB 504. The second BWP 502b is configured with an NCD-SSB 506. For example, the network may configure the NCD-SSB 506 using a NonCellDefiningSSB IE (e.g., as defined in 3GPP specifications). As further shown in FIG. 5, the third BWP 502c overlaps with the frequency resources that include the CD-SSB 504. Additionally, the third BWP 502c overlaps with frequency resources that include the NCD-SSB 506. In the example 500, NCD-SSBs may be configured only for BWPs that do not contain (that is, do not overlap in frequency with) the CD-SSB 504. In other words, NCD-SSBs are not configured for BWPs that contain (that is, overlap in frequency with) the CD-SSB 504. Accordingly, the network will refrain from including the NonCellDefiningSSB IE in the configuration for the third BWP 502c. Additionally, the UE 120 will discard any NonCellDefiningSSB IE that is not omitted from the configuration for the third BWP 502c.

In the example 500, when the network activates the third BWP 502c (e.g., transmits, to the UE 120, an instruction to move the third BWP 502c into an active state), the UE 120 may use the CD-SSB 504 for L1/L3 measurements as well as beam management (BM), radio link management (RLM), and beam failure detection (BFD). Additionally, the UE 120 and the network may use the CD-SSB 504 for resolving collisions. For example, the UE 120 may receive a downlink transmission based at least in part on resolving a collision between the downlink transmission and the CD-SSB 504 and/or may refrain from transmitting an uplink transmission based at least in part on resolving a collision between the uplink transmission and the CD-SSB 504. Additionally, the UE 120 and the network may use the CD-SSB 504 for random access. For example, the UE 120 may transmit a random access preamble based at least in part on determining a random access occasion (RO) using the CD-SSB 504.

In some aspects, the BWPs 502a, 502b, and 502c may be associated with an SCell configuration (e.g., received from the network). When the SCell is associated with a dormant state, the UE 120 may use the CD-SSB 504 for L1/L3 measurements on the SCell, regardless of whether the NCD-SSB 506 is configured. For example, the network may refrain from including the NonCellDefiningSSB IE in the configuration for the third BWP 502c based at least in part on third BWP 502c being associated with the dormant SCell. Additionally or alternatively, the UE 120 may discard any NonCellDefiningSSB IE that is not omitted from the configuration for the third BWP 502c based at least in part on third BWP 502c being associated with the dormant SCell. As used herein, “dormant state” refers to the SCell not providing downlink transmission to the UE 120 (e.g., physical downlink control channel (PDCCH) transmissions and/or physical downlink shared channel (PDSCH) transmission).

Similarly, when the SCell is associated with a deactivated state, the UE 120 may use the CD-SSB 504 for L1/L3 measurements on the SCell, regardless of whether the NCD-SSB 506 is configured. For example, the network may refrain from including the NonCellDefiningSSB IE in the configuration for the third BWP 502c based at least in part on third BWP 502c being associated with the deactivated SCell. Additionally, the UE 120 will discard any NonCellDefiningSSB IE that is not omitted from the configuration for the third BWP 502c based at least in part on third BWP 502c being associated with the deactivated SCell. As used herein, “deactivated state” refers to the SCell not providing downlink transmission to the UE 120 (e.g., PDCCH transmissions and/or PDSCH transmission) and refraining from providing channel state information (CSI) reference signals (CSI-RSs).

By using techniques as described in connection with FIG. 5, the UE 120 always uses the CD-SSB 504 when the CD-SSB 504 overlaps with an active BWP. As a result, the UE 120 and the network may perform collision resolution in the active BWP with few processing resources and little memory overhead.

As indicated above, FIG. 5 is provided as an example. Other examples may differ from what is described with respect to FIG. 5.

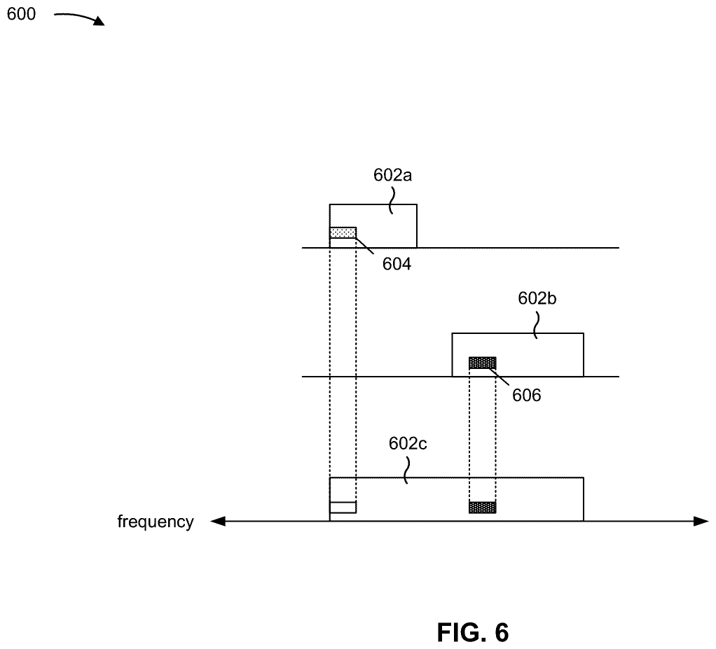

FIG. 6 is a diagram illustrating an example 600 associated with configuring and using NCD-SSBs, in accordance with the present disclosure. As shown in FIG. 6, example 600 includes a first BWP 602a, a second BWP 602b, and a third BWP 602c for a UE 120. Each BWP may be configured by a network using a BWP-DownlinkDedicated IE (e.g., as defined in 3GPP specifications).

The first BWP 602a overlaps with frequency resources that include a CD-SSB 604. The second BWP 602b is configured with an NCD-SSB 606. For example, the network may configure the NCD-SSB 606 using a NonCellDefiningSSB IE (e.g., as defined in 3GPP specifications). As further shown in FIG. 6, the third BWP 602c overlaps with the frequency resources that include the CD-SSB 604. Additionally, the third BWP 602c overlaps with frequency resources that include the NCD-SSB 606. In the example 600, the network may configure NCD-SSBs for any BWP. Accordingly, the network may include the NonCellDefiningSSB IE in the configuration for the third BWP 602c, such that the UE 120 will use the NCD-SSB 606 when the third BWP 602c is active. Alternatively, the network may omit the NonCellDefiningSSB IE in the configuration for the third BWP 602c, such that the UE 120 will use the CD-SSB 604 when the third BWP 602c is active.

In the example 600, when the network activates the third BWP 602c (e.g., transmits, to the UE 120, an instruction to move the third BWP 602c into an active state), the UE 120 may use the NCD-SSB 606 for L1/L3 measurements as well as BM, RLM, and BFD. Additionally, the UE 120 and the network may use the NCD-SSB 606 for resolving collisions. For example, the UE 120 may receive a downlink transmission based at least in part on resolving a collision between the downlink transmission and the NCD-SSB 606 and/or may refrain from transmitting an uplink transmission based at least in part on resolving a collision between the uplink transmission and the NCD-SSB 606. Additionally, the UE 120 and the network may use the NCD-SSB 606 for random access. For example, the UE 120 may transmit a random access preamble based at least in part on determining an RO using the NCD-SSB 606. Alternatively, the UE 120 may use the CD-SSB 604 for random access regardless of whether the NCD-SSB 606 is configured. For example, the UE 120 may transmit a random access preamble based at least in part on determining an RO using the CD-SSB 604. By using the CD-SSB 604 even when the NCD-SSB 606 is configured, the UE 120 may increase a quantity of symbols that are allowed to be used for random access, which reduces latency when the UE 120 is performing a RACH procedure. Furthermore, once the UE 120 identifies one or more valid ROs using the CD-SSB, the UE 120 may refrain from re-checking the valid RO(s) regardless of which BWP is active. The UE 120 may refrain from re-checking because the CD-SSB is identified at the UE 120 via higher-layer parameters (e.g., system information and/or a serving cell configuration) that is common for all DL BWPs of a cell, unlike NCD-SSBs that are configured per DL BWP configuration of the cell. In other words, if the UE 120 identifies valid RO(s) are using an NCD-SSB of the active DL BWP, the UE 120 may re-check the valid RO(s) depending on which DL BWP is active.

In some aspects, the BWPs 602a, 602b, and 602c may be associated with an SCell configuration (e.g., received from the network). When the SCell is associated with a dormant state, the network may configure the NCD-SSB 606 for L1/L3 measurements on the SCell. For example, the network may include the NonCellDefiningSSB IE in the configuration for the third BWP 602c.

Similarly, when the SCell is associated with a deactivated state, the UE 120 may use the NCD-SSB 606 for L1/L3 measurements on the SCell. For example, the network may indicate the third BWP 602c as the first active BWP configured for the SCell (e.g., using a firstActiveDownlinkBWP IE, as defined in 3GPP specifications) and may indicate the NCD-SSB 606 (e.g., by including a NonCellDefiningSSB IE in the firstActiveDownlinkBWP IE).

By using techniques as described in connection with FIG. 6, the network controls whether the NCD-SSB 606 is configured for an active BWP, the network may exercise greater control over measurements performed by the UE 120. As a result, the network may choose whether UE 120 will use the CD-SSB 604 or the NCD-SSB 606, and the network may thus increase quality and reliability of communications because transmission parameters are selected based on measurements of the SSB chosen by the network.

As indicated above, FIG. 6 is provided as an example. Other examples may differ from what is described with respect to FIG. 6.

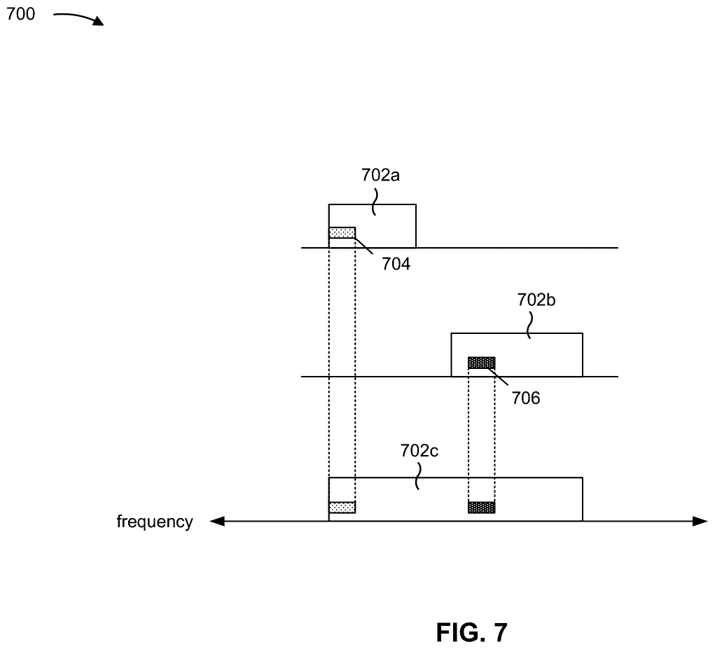

FIG. 7 is a diagram illustrating an example 700 associated with configuring and using NCD-SSBs, in accordance with the present disclosure. As shown in FIG. 7, example 700 includes a first BWP 702a, a second BWP 702b, and a third BWP 702c for a UE 120. Each BWP may be configured by a network using a BWP-DownlinkDedicated IE (e.g., as defined in 3GPP specifications).

The first BWP 702a overlaps with frequency resources that include a CD-SSB 704. The second BWP 702b is configured with an NCD-SSB 706. For example, the network may configure the NCD-SSB 706 using a NonCellDefiningSSB IE (e.g., as defined in 3GPP specifications). As further shown in FIG. 7, the third BWP 702c overlaps with the frequency resources that include the CD-SSB 704. Additionally, the third BWP 702c overlaps with frequency resources that include the NCD-SSB 706. In the example 700, the network may configure NCD-SSBs for any BWP. Accordingly, the network may include the NonCellDefiningSSB IE in the configuration for the third BWP 702c, such that the UE 120 will use both the CD-SSB 704 and the NCD-SSB 706 when the third BWP 702c is active. Alternatively, the network may omit the NonCellDefiningSSB IE in the configuration for the third BWP 702c, such that the UE 120 will use only the CD-SSB 704 when the third BWP 702c is active.

In the example 700, when the network activates the third BWP 702c (e.g., transmits, to the UE 120, an instruction to move the third BWP 702c into an active state), the UE 120 may either, or both, of the NCD-SSB 706 and the CD-SSB 704 for L1/L3 measurements as well as BM, RLM, and BFD. Additionally, the UE 120 and the network may use both the CD-SSB 704 and the NCD-SSB 706 for resolving collisions. For example, the UE 120 may receive a downlink transmission based at least in part on resolving a collision between the downlink transmission, the CD-SSB 704, and the NCD-SSB 706. Similarly, the UE 120 may refrain from transmitting an uplink transmission based at least in part on resolving a collision between the uplink transmission, the CD-SSB 704, and the NCD-SSB 706. Additionally, the UE 120 and the network may use both the CD-SSB 704 and the NCD-SSB 706 for random access. For example, the UE 120 may transmit a random access preamble based at least in part on determining an RO using the CD-SSB 704 and the NCD-SSB 706. Alternatively, the UE 120 may use the CD-SSB 704 for random access regardless of whether the NCD-SSB 706 is configured. For example, the UE 120 may transmit a random access preamble based at least in part on determining an RO using the CD-SSB 704. By using the CD-SSB 704 even when the NCD-SSB 706 is configured, the UE 120 may increase a quantity of symbols that are allowed to be used for random access, which reduces latency when the UE 120 is performing a RACH procedure. Furthermore, as described in connection with FIG. 6, once the UE 120 identifies one or more valid ROs using the CD-SSB, the UE 120 may refrain from re-checking the valid RO(s) regardless of which BWP is active.

By using techniques as described in connection with FIG. 7, the UE 120 may use both the CD-SSB 704 and the NCD-SSB 706. As a result, the UE 120 minimizes collision between the SSBs and uplink or downlink transmissions, which increases quality and reliability of communications with the network.

As indicated above, FIG. 7 is provided as an example. Other examples may differ from what is described with respect to FIG. 7.

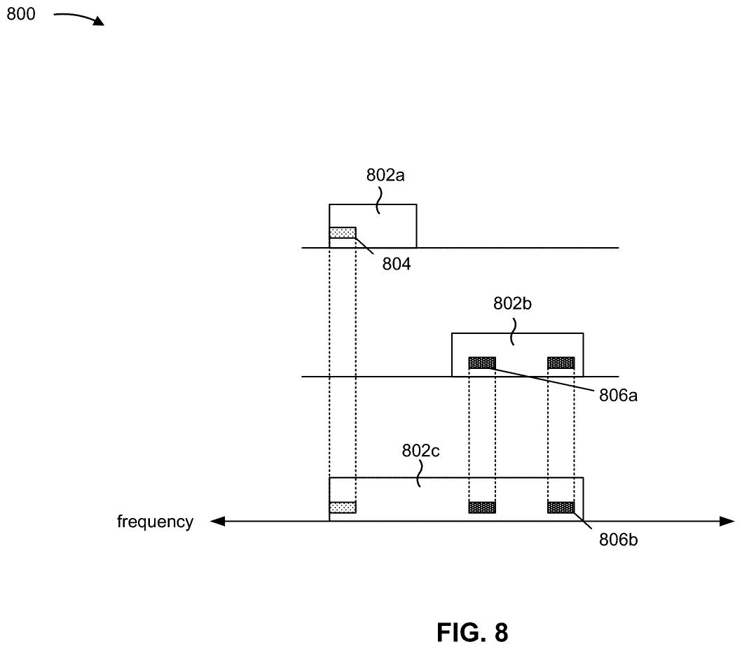

FIG. 8 is a diagram illustrating an example 800 associated with configuring and using NCD-SSBs, in accordance with the present disclosure. As shown in FIG. 8, example 800 includes a first BWP 802a, a second BWP 802b, and a third BWP 802c for a UE 120. Each BWP may be configured by a network using a BWP-DownlinkDedicated IE (e.g., as defined in 3GPP specifications).

The first BWP 802a overlaps with frequency resources that include a CD-SSB 704. The second BWP 802b is configured with an NCD-SSB 806a. For example, the network may configure the NCD-SSB 806a using a NonCellDefiningSSB IE (e.g., as defined in 3GPP specifications). As further shown in FIG. 8, the third BWP 802c overlaps with the frequency resources that include the CD-SSB 804. Additionally, the third BWP 802c overlaps with frequency resources that include the NCD-SSB 806a, and the network may configure the third BWP 802c with an NCD-SSB 806b using a NonCellDefiningSSB IE (e.g., as defined in 3GPP specifications). In the example 800, the UE 120 may use all NCD-SSBs that overlap with an active BWP. Accordingly, when the network activates the second BWP 802b (e.g., transmits, to the UE 120, an instruction to move the second BWP 802b into an active state), the UE 120 may either, or both, of the NCD-SSB 806a and the NCD-SSB 806b.

Similarly, in the example 800, when the network activates the third BWP 802c (e.g., transmits, to the UE 120, an instruction to move the third BWP 802c into an active state), the UE 120 may either, or both, of the CD-SSB 804, the NCD-SSB 806a, and the NCD-SSB 806b, for L1/L3 measurements as well as BM, RLM, and BFD. Additionally, the UE 120 and the network may use all of the CD-SSB 804, the NCD-SSB 806a, and the NCD-SSB 806b for resolving collisions. For example, the UE 120 may receive a downlink transmission based at least in part on resolving a collision between the downlink transmission, the CD-SSB 804, the NCD-SSB 806a, and the NCD-SSB 806b. Similarly, the UE 120 may refrain from transmitting an uplink transmission based at least in part on resolving a collision between the uplink transmission, the CD-SSB 804, the NCD-SSB 806a, and the NCD-SSB 806b. Additionally, the UE 120 and the network may use all of the CD-SSB 804, the NCD-SSB 806a, and the NCD-SSB 806b for random access. For example, the UE 120 may transmit a random access preamble based at least in part on determining an RO using the CD-SSB 804, the NCD-SSB 806a, and the NCD-SSB 806b. Alternatively, the UE 120 may use the CD-SSB 804 for random access regardless of overlapping NCD-SSBs. For example, the UE 120 may transmit a random access preamble based at least in part on determining an RO using the CD-SSB 804. By using the CD-SSB 804 even when NCD-SSBs are overlapping, the UE 120 may increase a quantity of symbols that are allowed to be used for random access, which reduces latency when the UE 120 is performing a RACH procedure.

By using techniques as described in connection with FIG. 8, the UE 120 may use the CD-SSB 804, the NCD-SSB 806a, and the NCD-SSB 806b. As a result, the UE 120 minimizes collision between the SSBs and uplink or downlink transmissions, which increases quality and reliability of communications with the network.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with using NCD-SSBs.

As shown in FIG. 9, in some aspects, process 900 may include receiving a configuration for a BWP, the BWP overlapping with one or more first frequency resources associated with a CD-SSB and one or more second frequency resources associated with an NCD-SSB (block 910). For example, the UE (e.g., using reception component 1702 and/or communication manager 1706, depicted in FIG. 17) may receive a configuration for a BWP, the BWP overlapping with one or more first frequency resources associated with a CD-SSB and one or more second frequency resources associated with an NCD-SSB, as described herein.

As further shown in FIG. 9, in some aspects, process 900 may include performing a measurement using the CD-SSB during an active state of the BWP (block 920). For example, the UE (e.g., using reception component 1702 and/or communication manager 1706) may perform a measurement using the CD-SSB during an active state of the BWP, as described herein.

Process 900 may include additional aspects, such as any single aspect or any combination of aspects described below and/or in connection with one or more other processes described elsewhere herein.

In a first aspect, process 900 includes receiving (e.g., using reception component 1702 and/or communication manager 1706) a downlink transmission based at least in part on resolving a collision between the downlink transmission and the CD-SSB.

In a second aspect, alone or in combination with the first aspect, process 900 includes refraining from transmitting (e.g., using transmission component 1704 and/or communication manager 1706, depicted in FIG. 17) an uplink transmission based at least in part on resolving a collision between the uplink transmission and the CD-SSB.

In a third aspect, alone or in combination with one or more of the first and second aspects, process 900 includes transmitting (e.g., using reception component 1702 and/or communication manager 1706) a random access preamble based at least in part on determining a random access occasion using the CD-SSB.

In a fourth aspect, alone or in combination with one or more of the first through third aspects, the configuration lacks an IE associated with the NCD-SSB.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with configuring NCD-SSBs.

As shown in FIG. 10, in some aspects, process 1000 may include transmitting a configuration for a BWP, the BWP overlapping with one or more first frequency resources associated with an NCD-SSB, and the configuration omitting an IE associated with the NCD-SSB based on the BWP overlapping with second frequency resources associated with a CD-SSB (block 1010). For example, the network node (e.g., using transmission component 1804 and/or communication manager 1806, depicted in FIG. 18) may transmit a configuration for a BWP, the BWP overlapping with one or more first frequency resources associated with an NCD-SSB, and the configuration omitting an IE associated with the NCD-SSB based on the BWP overlapping with second frequency resources associated with a CD-SSB, as described herein.

As further shown in FIG. 10, in some aspects, process 1000 may include transmitting an instruction to move the BWP into an active state (block 1020). For example, the network node (e.g., using transmission component 1804 and/or communication manager 1806) may transmit an instruction to move the BWP into an active state, as described herein.

Process 1000 may include additional aspects, such as any single aspect or any combination of aspects described below and/or in connection with one or more other processes described elsewhere herein.

In a first aspect, process 1000 includes transmitting (e.g., using transmission component 1804 and/or communication manager 1806) a downlink transmission based at least in part on resolving a collision between the downlink transmission and the CD-SSB.

In a second aspect, alone or in combination with the first aspect, process 1000 includes refraining from monitoring (e.g., using reception component 1802 and/or communication manager 1806, depicted in FIG. 18) for an uplink transmission based at least in part on resolving a collision between the uplink transmission and the CD-SSB.

In a third aspect, alone or in combination with one or more of the first and second aspects, process 1000 includes receiving (e.g., using reception component 1802 and/or communication manager 1806) a random access preamble based at least in part on determining a random access occasion using the CD-SSB.

In a fourth aspect, alone or in combination with one or more of the first through third aspects, process 1000 includes receiving (e.g., using reception component 1802 and/or communication manager 1806) an indication of a measurement, based at least in part on the CD-SSB, during the active state of the BWP.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with using the NCD-SSB.

As shown in FIG. 11, in some aspects, process 1100 may include receiving a configuration for a BWP, the configuration indicating an NCD-SSB included in the BWP, and the BWP overlapping with one or more frequency resources associated with a CD-SSB (block 1110). For example, the UE (e.g., using reception component 1702 and/or communication manager 1706, depicted in FIG. 17) may receive a configuration for a BWP, the configuration indicating an NCD-SSB included in the BWP, and the BWP overlapping with one or more frequency resources associated with a CD-SSB, as described herein.

As further shown in FIG. 11, in some aspects, process 1100 may include performing a measurement using the NCD-SSB during an active state of the BWP (block 1120). For example, the UE (e.g., using reception component 1702 and/or communication manager 1706) may perform a measurement using the NCD-SSB during an active state of the BWP, as described herein.

Process 1100 may include additional aspects, such as any single aspect or any combination of aspects described below and/or in connection with one or more other processes described elsewhere herein.

In a first aspect, process 1100 includes receiving (e.g., using reception component 1702 and/or communication manager 1706) a downlink transmission based at least in part on resolving a collision between the downlink transmission and the NCD-SSB.

In a second aspect, alone or in combination with the first aspect, process 1100 includes refraining from transmitting (e.g., using transmission component 1704 and/or communication manager 1706, depicted in FIG. 17) an uplink transmission based at least in part on resolving a collision between the uplink transmission and the NCD-SSB.

In a third aspect, alone or in combination with one or more of the first and second aspects, process 1100 includes transmitting (e.g., using transmission component 1704 and/or communication manager 1706) a random access preamble based at least in part on determining a random access occasion using the NCD-SSB.

In a fourth aspect, alone or in combination with one or more of the first through third aspects, process 1100 includes transmitting (e.g., using transmission component 1704 and/or communication manager 1706) a random access preamble based at least in part on determining a random access occasion using the CD-SSB.

In a fifth aspects, alone in combination with one or more of the first through fourth aspects, process 1100 includes performing (e.g., using communication manager 1706) beam management using the NCD-SSB.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with configuring NCD-SSBs.

As shown in FIG. 12, in some aspects, process 1200 may include transmitting a configuration for a BWP, the configuration indicating an NCD-SSB included in the BWP, and the BWP overlapping with one or more frequency resources associated with a CD-SSB (block 1210). For example, the network node (e.g., using transmission component 1804 and/or communication manager 1806, depicted in FIG. 18) may transmit a configuration for a BWP, the configuration indicating an NCD-SSB included in the BWP, and the BWP overlapping with one or more frequency resources associated with a CD-SSB, as described herein.

As further shown in FIG. 12, in some aspects, process 1200 may include transmitting an instruction to move the BWP into an active state (block 1220). For example, the network node (e.g., using transmission component 1804 and/or communication manager 1806) may transmit an instruction to move the BWP into an active state, as described herein.

Process 1200 may include additional aspects, such as any single aspect or any combination of aspects described below and/or in connection with one or more other processes described elsewhere herein.

In a first aspect, process 1200 includes transmitting (e.g., using transmission component 1804 and/or communication manager 1806) a downlink transmission based at least in part on resolving a collision between the downlink transmission and the NCD-SSB.

In a second aspect, alone or in combination with the first aspect, process 1200 includes refraining from monitoring (e.g., using reception component 1802 and/or communication manager 1806, depicted in FIG. 18) for an uplink transmission based at least in part on resolving a collision between the uplink transmission and the NCD-SSB.

In a third aspect, alone or in combination with one or more of the first and second aspects, process 1200 includes receiving (e.g., using reception component 1802 and/or communication manager 1806) a random access preamble based at least in part on determining a random access occasion using the NCD-SSB.

In a fourth aspect, alone or in combination with one or more of the first through third aspects, process 1200 includes receiving (e.g., using reception component 1802 and/or communication manager 1806) a random access preamble based at least in part on determining a random access occasion using the CD-SSB.

In a fifth aspect, alone or in combination with one or more of the first through fourth aspects, process 1200 includes receiving (e.g., using reception component 1802 and/or communication manager 1806) an indication of a measurement, based at least in part on the NCD-SSB, during the active state of the BWP.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with using NCD-SSBs.

As shown in FIG. 13, in some aspects, process 1300 may include receiving a configuration for a BWP, the configuration indicating a NCD-SSB included in the BWP, and the BWP including one or more frequency resources associated with a CD-SSB (block 1310). For example, the UE (e.g., using reception component 1702 and/or communication manager 1706, depicted in FIG. 17) may receive a configuration for a BWP, the configuration indicating a NCD-SSB included in the BWP, and the BWP including one or more frequency resources associated with a CD-SSB, as described herein.

As further shown in FIG. 13, in some aspects, process 1300 may include performing a measurement using at least one of the CD-SSB or the NCD-SSB during an active state of the BWP (block 1320). For example, the UE (e.g., using reception component 1702 and/or communication manager 1706) may perform a measurement using at least one of the CD-SSB or the NCD-SSB during an active state of the BWP, as described herein.

Process 1300 may include additional aspects, such as any single aspect or any combination of aspects described below and/or in connection with one or more other processes described elsewhere herein.

In a first aspect, process 1300 includes receiving (e.g., using reception component 1702 and/or communication manager 1706) a downlink transmission based at least in part on resolving a collision between the downlink transmission, the NCD-SSB, and the CD-SSB.

In a second aspect, alone or in combination with the first aspect, process 1300 includes refraining from transmitting (e.g., using transmission component 1704 and/or communication manager 1706, depicted in FIG. 17) an uplink transmission based at least in part on resolving a collision between the uplink transmission, the NCD-SSB, and the CD-SSB.

In a third aspect, alone or in combination with one or more of the first and second aspects, process 1300 includes transmitting (e.g., using transmission component 1704 and/or communication manager 1706) a random access preamble based at least in part on determining a random access occasion using the NCD-SSB and the CD-SSB.

In a fourth aspect, alone or in combination with one or more of the first through third aspects, process 1300 includes transmitting (e.g., using transmission component 1704 and/or communication manager 1706) a random access preamble based at least in part on determining a random access occasion using the CD-SSB.

In a fifth aspect, alone or in combination with one or more of the first through fourth aspects, process 1300 includes performing an additional measurement (e.g., using transmission component 1704 and/or communication manager 1706) using the other of the CD-SSB or the NCD-SSB during an active state of the BWP.

In a sixth aspect, alone or in combination with one or more of the first through fifth aspects, the configuration further indicates an additional NCD-SSB included in the BWP, and process 1300 includes performing an additional measurement (e.g., using transmission component 1704 and/or communication manager 1706) using the additional NCD-SSB during an active state of the BWP.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with configuring NCD-SSBs.

As shown in FIG. 14, in some aspects, process 1400 may include transmitting a configuration for a BWP, the configuration indicating an NCD-SSB included in the BWP, and the BWP overlapping with one or more frequency resources associated with a CD-SSB (block 1410). For example, the network node (e.g., using transmission component 1804 and/or communication manager 1806, depicted in FIG. 18) may transmit a configuration for a BWP, the configuration indicating an NCD-SSB included in the BWP, and the BWP overlapping with one or more frequency resources associated with a CD-SSB, as described herein.

As further shown in FIG. 14, in some aspects, process 1400 may include receiving an indication of a first measurement, based at least in part on the NCD-SSB, during an active state of the BWP (block 1420). For example, the network node (e.g., using reception component 1802 and/or communication manager 1806, depicted in FIG. 18) may receive an indication of a first measurement, based at least in part on the NCD-SSB, during an active state of the BWP, as described herein.

As further shown in FIG. 14, in some aspects, process 1400 may include receiving an indication of a second measurement, based at least in part on the CD-SSB, during the active state of the BWP (block 1430). For example, the network node (e.g., using reception component 1802 and/or communication manager 1806) may receive an indication of a second measurement, based at least in part on the CD-SSB, during the active state of the BWP, as described herein.

Process 1400 may include additional aspects, such as any single aspect or any combination of aspects described below and/or in connection with one or more other processes described elsewhere herein.

In a first aspect, process 1400 includes transmitting (e.g., using transmission component 1804 and/or communication manager 1806) a downlink transmission based at least in part on resolving a collision between the downlink transmission, the NCD-SSB, and the CD-SSB.

In a second aspect, alone or in combination with the first aspect, process 1400 includes refraining from monitoring (e.g., using reception component 1802 and/or communication manager 1806) for an uplink transmission based at least in part on resolving a collision between the uplink transmission, the NCD-SSB, and the CD-SSB.

In a third aspect, alone or in combination with one or more of the first and second aspects, process 1400 includes receiving (e.g., using reception component 1802 and/or communication manager 1806) a random access preamble based at least in part on determining a random access occasion using the NCD-SSB and the CD-SSB.

In a fourth aspect, alone or in combination with one or more of the first through third aspects, process 1400 includes receiving (e.g., using reception component 1802 and/or communication manager 1806) a random access preamble based at least in part on determining a random access occasion using the CD-SSB.

In a fifth aspect, alone or in combination with one or more of the first through fourth aspects, the configuration further indicates an additional NCD-SSB included in the BWP, and process 1400 includes receiving (e.g., using reception component 1802 and/or communication manager 1806) an indication of a third measurement, based at least in part on the additional NCD-SSB, during the active state of the BWP.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a UE or an apparatus of a UE, in accordance with the present disclosure. Example process 1500 is an example where the apparatus or the UE (e.g., UE 120) performs operations associated with using NCD-SSBs.

As shown in FIG. 15, in some aspects, process 1500 may include receiving a configuration for an SCell in a dormant state or a deactivated state (block 1510). For example, the UE (e.g., using reception component 1702 and/or communication manager 1706, depicted in FIG. 17) may receive a configuration for an SCell in a dormant state or a deactivated state, as described herein.

As further shown in FIG. 15, in some aspects, process 1500 may include performing a measurement on the SCell using an NCD-SSB (block 1520). For example, the UE (e.g., using reception component 1702 and/or communication manager 1706) may perform a measurement on the SCell using an NCD-SSB, as described herein.

Process 1500 may include additional aspects, such as any single aspect or any combination of aspects described below and/or in connection with one or more other processes described elsewhere herein.

In a first aspect, process 1500 includes receiving (e.g., using reception component 1702 and/or communication manager 1706) a configuration for the NCD-SSB.

In a second aspect, alone or in combination with the first aspect, the NCD-SSB is included in a first active BWP configured for the SCell.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a network node or an apparatus of a network node, in accordance with the present disclosure. Example process 1600 is an example where the apparatus or the network node (e.g., network node 110) performs operations associated with configuring NCD-SSBs.

As shown in FIG. 16, in some aspects, process 1600 may include transmitting a configuration for an SCell in a dormant state or a deactivated state (block 1610). For example, the network node (e.g., using transmission component 1804 and/or communication manager 1806, depicted in FIG. 18) may transmit a configuration for an SCell in a dormant state or a deactivated state, as described herein.

As further shown in FIG. 16, in some aspects, process 1600 may include transmitting a configuration associated with an NCD-SSB for use in the SCell (block 1620). For example, the network node (e.g., using transmission component 1804 and/or communication manager 1806) may transmit a configuration associated with an NCD-SSB for use in the SCell, as described herein.

Process 1600 may include additional aspects, such as any single aspect or any combination of aspects described below and/or in connection with one or more other processes described elsewhere herein.

In a first aspect, the configuration associated with the NCD-SSB includes an IE for the NCD-SSB.

In a second aspect, alone or in combination with the first aspect, the configuration associated with the NCD-SSB includes an IE for a first active BWP configured for the SCell.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication, in accordance with the present disclosure. The apparatus 1700 may be a UE, or a UE may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 140 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 5-8. Additionally, or alternatively, the apparatus 1700 may be configured to perform one or more processes described herein, such as process 900 of FIG. 9, process 1100 of FIG. 11, process 1300 of FIG. 13, process 1500 of FIG. 15, or a combination thereof. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1704 may be co-located with the reception component 1702 in one or more transceivers.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

In some aspects, the reception component 1702 may receive (e.g., from the apparatus 1708) a configuration for a BWP that overlaps with one or more first frequency resources associated with a CD-SSB and one or more second frequency resources associated with an NCD-SSB. The communication manager 1706 may perform a measurement using the CD-SSB during an active state of the BWP. In some aspects, the reception component 1702 may receive a downlink transmission (e.g., from the apparatus 1708) based at least in part on resolving a collision between the downlink transmission and the CD-SSB. Additionally, or alternatively, the communication manager 1706 may refrain from transmitting an uplink transmission (e.g., to the apparatus 1708) based at least in part on resolving a collision between the uplink transmission and the CD-SSB. In some aspects, the transmission component 1704 may transmit a random access preamble (e.g., to the apparatus 1708) based at least in part on determining a random access occasion using the CD-SSB.

In some aspects, the reception component 1702 may receive (e.g., from the apparatus 1708) a configuration for a BWP, the configuration indicating an NCD-SSB included in the BWP, and the BWP overlapping with one or more frequency resources associated with a CD-SSB. The communication manager 1706 may perform a measurement using the NCD-SSB during an active state of the BWP. In some aspects, the reception component 1702 may receive a downlink transmission (e.g., from the apparatus 1708) based at least in part on resolving a collision between the downlink transmission and the NCD-SSB. Additionally, or alternatively, the communication manager 1706 may refrain from transmitting an uplink transmission (e.g., to the apparatus 1708) based at least in part on resolving a collision between the uplink transmission and the NCD-SSB. Additionally, or alternatively, the communication manager 1706 may perform beam management using the NCD-SSB. In some aspects, the transmission component 1704 may transmit a random access preamble (e.g., to the apparatus 1708) based at least in part on determining a random access occasion using the NCD-SSB. Alternatively, the transmission component 1704 may transmit a random access preamble (e.g., to the apparatus 1708) based at least in part on determining a random access occasion using the CD-SSB.

In some aspects, the reception component 1702 may receive (e.g., from the apparatus 1708) a configuration for a BWP, the configuration indicating an NCD-SSB included in the BWP, and the BWP including one or more frequency resources associated with a CD-SSB. The communication manager 1706 may perform a measurement using at least one of the CD-SSB or the NCD-SSB during an active state of the BWP. In some aspects, the reception component 1702 may receive a downlink transmission (e.g., from the apparatus 1708) based at least in part on resolving a collision between downlink transmission, the NCD-SSB, and the CD-SSB. Additionally, or alternatively, the communication manager 1706 may refrain from transmitting an uplink transmission (e.g., to the apparatus 1708) based at least in part on resolving a collision between the uplink transmission, the NCD-SSB, and the CD-SSB. In some aspects, the transmission component 1704 may transmit a random access preamble (e.g., to the apparatus 1708) based at least in part on determining a random access occasion using the NCD-SSB and the CD-SSB. Alternatively, the transmission component 1704 may transmit a random access preamble (e.g., to the apparatus 1708) based at least in part on determining a random access occasion using the CD-SSB.

In some aspects, the reception component 1702 may receive (e.g., from the apparatus 1708) a configuration for an SCell. The SCell may be in a dormant state or a deactivated state, and the communication manager 1706 may perform a measurement on the SCell using an NCD-SSB. In some aspects, the reception component 1702 may receive (e.g., from the apparatus 1708) a configuration for the NCD-SSB.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication, in accordance with the present disclosure. The apparatus 1800 may be a network node, or a network node may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 150 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 5-8. Additionally, or alternatively, the apparatus 1800 may be configured to perform one or more processes described herein, such as process 1000 of FIG. 10, process 1200 of FIG. 12, process 1400 of FIG. 14, process 1600 of FIG. 16, or a combination thereof. In some aspects, the apparatus 1800 and/or one or more components shown in FIG. 18 may include one or more components of the network node described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1802 and/or the transmission component 1804 may include or may be included in a network interface. The network interface may be configured to obtain and/or output signals for the apparatus 1800 via one or more communications links, such as a backhaul link, a midhaul link, and/or a fronthaul link.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1804 may be co-located with the reception component 1802 in one or more transceivers.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

In some aspects, the transmission component 1804 may transmit (e.g., to the apparatus 1808) a configuration for a BWP, the BWP overlapping with one or more first frequency resources associated with an NCD-SSB, and the configuration omitting an IE associated with the NCD-SSB based on the BWP overlapping with second frequency resources associated with a CD-SSB. The transmission component 1804 may transmit an instruction to move the BWP into an active state, and the reception component 1802 may receive an indication of a measurement (e.g., from the apparatus 1808), based at least in part on the CD-SSB, during the active state of the BWP. In some aspects, the transmission component 1804 may transmit a downlink transmission (e.g., to the apparatus 1808) based at least in part on resolving a collision between the downlink transmission and the CD-SSB. Additionally, or alternatively, the communication manager 1806 may refrain from monitoring for an uplink transmission (e.g., from the apparatus 1808) based at least in part on resolving a collision between the uplink transmission and the CD-SSB. In some aspects, the reception component 1802 may receive a random access preamble (e.g., from the apparatus 1808) based at least in part on determining a random access occasion using the CD-SSB.

In some aspects, the transmission component 1804 may transmit (e.g., to the apparatus 1808) a configuration for a BWP, the configuration indicating an NCD-SSB included in the BWP, and the BWP overlapping with one or more frequency resources associated with a CD-SSB. The transmission component 1804 may transmit an instruction to move the BWP into an active state, and the reception component 1802 may receive an indication of a measurement (e.g., from the apparatus 1808), based at least in part on the NCD-SSB, during the active state of the BWP. In some aspects, the transmission component 1804 may transmit a downlink transmission (e.g., to the apparatus 1808) based at least in part on resolving a collision between the downlink transmission and the NCD-SSB. Additionally, or alternatively, the communication manager 1806 may refrain from monitoring for an uplink transmission (e.g., from the apparatus 1808) based at least in part on resolving a collision between the uplink transmission and the NCD-SSB. In some aspects, the reception component 1802 may receive a random access preamble (e.g., from the apparatus 1808) based at least in part on determining a random access occasion using the NCD-SSB. Alternatively, the reception component 1802 may receive a random access preamble (e.g., from the apparatus 1808) based at least in part on determining a random access occasion using the CD-SSB.

In some aspects, the transmission component 1804 may transmit (e.g., to the apparatus 1808) a configuration for a BWP, the configuration indicating an NCD-SSB included in the BWP, and the BWP overlapping with one or more frequency resources associated with a CD-SSB. The reception component 1802 may receive an indication of a first measurement (e.g., from the apparatus 1808), based at least in part on the NCD-SSB, during an active state of the BWP. The reception component 1802 may receive an indication of a second measurement (e.g., from the apparatus 1808), based at least in part on the CD-SSB, during the active state of the BWP. In some aspects, the transmission component 1804 may transmit a downlink transmission (e.g., to the apparatus 1808) based at least in part on resolving a collision between the downlink transmission, the NCD-SSB, and the CD-SSB. Additionally, or alternatively, the communication manager 1806 may refrain from monitoring for an uplink transmission (e.g., from the apparatus 1808) based at least in part on resolving a collision between the uplink transmission, the NCD-SSB, and the CD-SSB. In some aspects, the reception component 1802 may receive a random access preamble (e.g., from the apparatus 1808) based at least in part on determining a random access occasion using the NCD-SSB and the CD-SSB. Alternatively, the reception component 1802 may receive a random access preamble (e.g., from the apparatus 1808) based at least in part on determining a random access occasion using the CD-SSB.

In some aspects, the transmission component 1804 may transmit (e.g., to the apparatus 1808) a configuration for an SCell. The SCell may be in a dormant state or a deactivated state, and the transmission component 1804 may transmit a configuration associated with an NCD-SSB for use in the SCell.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a user equipment (UE), comprising: receiving a configuration for a bandwidth part (BWP), the BWP overlapping with one or more first frequency resources associated with a cell-defining synchronization signal block (CD-SSB) and one or more second frequency resources associated with a non-cell-defining synchronization signal block (NCD-SSB); and performing a measurement using the CD-SSB during an active state of the BWP.

Aspect 2: The method of Aspect 1, further comprising: receiving a downlink transmission based at least in part on resolving a collision between the downlink transmission and the CD-SSB.

Aspect 3: The method of any of Aspects 1-2, further comprising: refraining from transmitting an uplink transmission based at least in part on resolving a collision between the uplink transmission and the CD-SSB.

Aspect 4: The method of any of Aspects 1-3, further comprising: transmitting a random access preamble based at least in part on determining a random access occasion using the CD-SSB.

Aspect 5: The method of any of Aspects 1-4, wherein the configuration lacks an information element associated with the NCD-SSB.

Aspect 6: A method of wireless communication performed by a network node, comprising: transmitting a configuration for a bandwidth part (BWP), the BWP overlapping with one or more first frequency resources associated with a non-cell-defining synchronization signal block (NCD-SSB), wherein the configuration omits an information element associated with the NCD-SSB based on the BWP overlapping with second frequency resources associated with a cell-defining synchronization signal block (CD-SSB); and transmitting an instruction to move the BWP into an active state.

Aspect 7: The method of Aspect 6, further comprising: transmitting a downlink transmission based at least in part on resolving a collision between the downlink transmission and the CD-SSB.

Aspect 8: The method of any of Aspects 6-7, further comprising: refraining from monitoring for an uplink transmission based at least in part on resolving a collision between the uplink transmission and the CD-SSB.

Aspect 9: The method of any of Aspects 6-8, further comprising: receiving a random access preamble based at least in part on determining a random access occasion using the CD-SSB.

Aspect 10: The method of any of Aspects 6-9, further comprising: receiving an indication of a measurement, based at least in part on the CD-SSB, during the active state of the BWP.

Aspect 11: A method of wireless communication performed by a user equipment (UE), comprising: receiving a configuration for a bandwidth part (BWP), the configuration indicating a non-cell-defining synchronization signal block (NCD-SSB) included in the BWP, and the BWP overlapping with one or more frequency resources associated with a cell-defining synchronization signal block (CD-SSB); and performing a measurement using the NCD-SSB during an active state of the BWP.

Aspect 12: The method of Aspect 11, further comprising: receiving a downlink transmission based at least in part on resolving a collision between the downlink transmission and the NCD-SSB.

Aspect 13: The method of any of Aspects 11-12, further comprising: refraining from transmitting an uplink transmission based at least in part on resolving a collision between the uplink transmission and the NCD-SSB.

Aspect 14: The method of any of Aspects 11-13, further comprising: transmitting a random access preamble based at least in part on determining a random access occasion using the NCD-SSB.

Aspect 15: The method of any of Aspects 11-13, further comprising: transmitting a random access preamble based at least in part on determining a random access occasion using the CD-SSB.

Aspect 16: The method of any of Aspects 11-15, further comprising: performing beam management using the NCD-SSB.

Aspect 17: A method of wireless communication performed by a network node, comprising: transmitting a configuration for a bandwidth part (BWP), the configuration indicating a non-cell-defining synchronization signal block (NCD-SSB) included in the BWP, and the BWP overlapping with one or more frequency resources associated with a cell-defining synchronization signal block (CD-SSB); and transmitting an instruction to move the BWP into an active state.

Aspect 18: The method of Aspect 17, further comprising: transmitting a downlink transmission based at least in part on resolving a collision between the downlink transmission and the NCD-SSB.

Aspect 19: The method of any of Aspects 17-18, further comprising: refraining from monitoring for an uplink transmission based at least in part on resolving a collision between the uplink transmission and the NCD-SSB.

Aspect 20: The method of any of Aspects 17-19, further comprising: receiving a random access preamble based at least in part on determining a random access occasion using the NCD-SSB.

Aspect 21: The method of any of Aspects 17-19, further comprising: receiving a random access preamble based at least in part on determining a random access occasion using the CD-SSB.

Aspect 22: The method of any of Aspects 17-21, further comprising: receiving an indication of a measurement, based at least in part on the NCD-SSB, during the active state of the BWP.

Aspect 23: A method of wireless communication performed by a user equipment (UE), comprising: receiving a configuration for a bandwidth part (BWP), the configuration indicating a non-cell-defining synchronization signal block (NCD-SSB) included in the BWP, and the BWP including one or more frequency resources associated with a cell-defining synchronization signal block (CD-SSB); and performing a measurement using at least one of the CD-SSB or the NCD-SSB during an active state of the BWP.

Aspect 24: The method of Aspect 23, further comprising: receiving a downlink transmission based at least in part on resolving a collision between the downlink transmission, the NCD-SSB, and the CD-SSB.

Aspect 25: The method of any of Aspects 23-24, further comprising: refraining from transmitting an uplink transmission based at least in part on resolving a collision between the uplink transmission, the NCD-SSB, and the CD-SSB.

Aspect 26: The method of any of Aspects 23-25, further comprising: transmitting a random access preamble based at least in part on determining a random access occasion using the NCD-SSB and the CD-SSB.

Aspect 27: The method of any of Aspects 23-25, further comprising: transmitting a random access preamble based at least in part on determining a random access occasion using the CD-SSB.

Aspect 28: The method of any of Aspects 23-27, further comprising: performing an additional measurement using the other of the CD-SSB or the NCD-SSB during an active state of the BWP.

Aspect 29: The method of any of Aspects 23-28, wherein the configuration further indicates an additional NCD-SSB included in the BWP, and the method further comprises: performing an additional measurement using the additional NCD-SSB during an active state of the BWP.

Aspect 30: A method of wireless communication performed by a network node, comprising: transmitting a configuration for a bandwidth part (BWP), the configuration indicating a non-cell-defining synchronization signal block (NCD-SSB) included in the BWP, and the BWP overlapping with one or more frequency resources associated with a cell-defining synchronization signal block (CD-SSB); receiving an indication of a first measurement, based at least in part on the NCD-SSB, during an active state of the BWP; and receiving an indication of a second measurement, based at least in part on the CD-SSB, during the active state of the BWP.

Aspect 31: The method of Aspect 30, further comprising: transmitting a downlink transmission based at least in part on resolving a collision between the downlink transmission, the NCD-SSB, and the CD-SSB.

Aspect 32: The method of any of Aspects 30-31, further comprising: refraining from monitoring for an uplink transmission based at least in part on resolving a collision between the uplink transmission, the NCD-SSB, and the CD-SSB.

Aspect 33: The method of any of Aspects 30-32, further comprising: receiving a random access preamble based at least in part on determining a random access occasion using the NCD-SSB and the CD-SSB.

Aspect 34: The method of any of Aspects 30-32, further comprising: receiving a random access preamble based at least in part on determining a random access occasion using the CD-SSB.

Aspect 35: The method of any of Aspects 30-34, wherein the configuration further indicates an additional NCD-SSB included in the BWP, and the method further comprises: receiving an indication of a third measurement, based at least in part on the additional NCD-SSB, during the active state of the BWP.

Aspect 36: A method of wireless communication performed by a user equipment (UE), comprising: receiving a configuration for a secondary cell (SCell), the SCell being in a dormant state or a deactivated state; and performing a measurement on the SCell using a non-cell-defining synchronization signal block (NCD-SSB).

Aspect 37: The method of Aspect 36, further comprising: receiving a configuration for the NCD-SSB.

Aspect 38: The method of any of Aspects 36-37, wherein the NCD-SSB is included in a first active bandwidth part configured for the SCell.

Aspect 39: A method of wireless communication performed by a network node, comprising: transmitting a configuration for a secondary cell (SCell), the SCell being in a dormant state or a deactivated state; and transmitting a configuration associated with a non-cell-defining synchronization signal block (NCD-SSB) for use in the SCell.

Aspect 40: The method of Aspect 39, wherein the configuration associated with the NCD-SSB includes an information element for the NCD-SSB.

Aspect 41: The method of any of Aspects 39-40, wherein the configuration associated with the NCD-SSB includes an information element for a first active bandwidth part configured for the SCell.

Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-41.

Aspect 43: An apparatus for wireless communication at a device, the apparatus comprising one or more memories and one or more processors coupled to the one or more memories, the one or more processors configured to cause the device to perform the method of one or more of Aspects 1-41.

Aspect 44: An apparatus for wireless communication, the apparatus comprising at least one means for performing the method of one or more of Aspects 1-41.

Aspect 45: A non-transitory computer-readable medium storing code for wireless communication, the code comprising instructions executable by one or more processors to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

Aspect 47: A device for wireless communication, the device comprising a processing system that includes one or more processors and one or more memories coupled with the one or more processors, the processing system configured to cause the device to perform the method of one or more of Aspects 1-41.

Aspect 48: An apparatus for wireless communication at a device, the apparatus comprising one or more memories and one or more processors coupled to the one or more memories, the one or more processors individually or collectively configured to cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “of” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, the one or more processors, individually or collectively and based at least in part on information stored in the one or more memories, being configured to:
receive a configuration for a bandwidth part (BWP), the configuration indicating a non-cell-defining synchronization signal block (NCD-SSB) included in the BWP, and the BWP overlapping with one or more frequency resources associated with a cell-defining synchronization signal block (CD-SSB); and
perform a measurement using the NCD-SSB during an active state of the BWP.

2. The apparatus of claim 1, wherein the one or more processors, individually or collectively and based at least in part on information stored in the one or more memories, are configured to:
receive a downlink transmission based at least in part on resolving a collision between the downlink transmission and the NCD-SSB.

3. The apparatus of claim 1, wherein the one or more processors, individually or collectively and based at least in part on information stored in the one or more memories, are configured to:
refrain from transmitting an uplink transmission based at least in part on resolving a collision between the uplink transmission and the NCD-SSB.

4. The apparatus of claim 1, wherein the one or more processors, individually or collectively and based at least in part on information stored in the one or more memories, are configured to:
transmit a random access preamble based at least in part on determining a random access occasion using the NCD-SSB.

5. The apparatus of claim 1, wherein the one or more processors, individually or collectively and based at least in part on information stored in the one or more memories, are configured to:
transmit a random access preamble based at least in part on determining a random access occasion using the CD-SSB.

6. The apparatus of claim 1, wherein the one or more processors, individually or collectively and based at least in part on information stored in the one or more memories, are configured to:
perform beam management using the NCD-SSB.

7. A method of wireless communication performed by a user equipment (UE), comprising:
receiving, at the UE, a configuration for a bandwidth part (BWP), the configuration indicating a non-cell-defining synchronization signal block (NCD-SSB) included in the BWP, and the BWP overlapping with one or more frequency resources associated with a cell-defining synchronization signal block (CD-SSB); and
performing, by the UE, a measurement using the NCD-SSB during an active state of the BWP.

8. The method of claim 7, further comprising:
receiving, at the UE, a downlink transmission based at least in part on resolving a collision between the downlink transmission and the NCD-SSB.

9. The method of claim 7, further comprising:
refraining from transmitting, by the UE, an uplink transmission based at least in part on resolving a collision between the uplink transmission and the NCD-SSB.

10. The method of claim 7, further comprising:
transmitting, by the UE, a random access preamble based at least in part on determining a random access occasion using the NCD-SSB.

11. The method of claim 7, further comprising:
transmitting, by the UE, a random access preamble based at least in part on determining a random access occasion using the CD-SSB.

12. The method of claim 7, further comprising:
performing, by the UE, beam management using the NCD-SSB.

13. A non-transitory computer-readable medium storing a set of instructions for wireless communication, the set of instructions comprising:
one or more instructions that, when executed by one or more processors of a user equipment (UE), cause the UE to:
receive a configuration for a bandwidth part (BWP), the configuration indicating a non-cell-defining synchronization signal block (NCD-SSB) included in the BWP, and the BWP overlapping with one or more frequency resources associated with a cell-defining synchronization signal block (CD-SSB); and
perform a measurement using the NCD-SSB during an active state of the BWP.

14. The non-transitory computer-readable medium of claim 13, wherein the one or more instructions further cause the UE to:
receive a downlink transmission based at least in part on resolving a collision between the downlink transmission and the NCD-SSB.

15. The non-transitory computer-readable medium of claim 13, wherein the one or more instructions further cause the UE to:
refrain from transmitting an uplink transmission based at least in part on resolving a collision between the uplink transmission and the NCD-SSB.

16. The non-transitory computer-readable medium of claim 13, wherein the one or more instructions further cause the UE to:
transmit a random access preamble based at least in part on determining a random access occasion using the NCD-SSB.

17. The non-transitory computer-readable medium of claim 13, wherein the one or more instructions further cause the UE to:
transmit a random access preamble based at least in part on determining a random access occasion using the CD-SSB.

18. The non-transitory computer-readable medium of claim 13, wherein the one or more instructions further cause the UE to:
perform beam management using the NCD-SSB.
